(19) United States
(12) Patent Application Publication
(10) Pub. No.: US 2013/0226469 A1
(43) Pub. Date: Aug. 29, 2013

(54) GATE-FREE FLOW CYTOMETRY DATA ANALYSIS

(71) Applicant: Purdue Research Foundation, (US)

(72) Inventors: Joseph Paul Robinson, West Lafayette, IN (US); Vincent Jo Davisson, West Lafayette, IN (US); Valeri P. Patsekin, West Lafayette, IN (US); Bartolomej Rajwa, West Lafayette, IN (US)

(73) Assignee: Purdue Research Foundation, West Lafayette, IN (US)

(21) Appl. No.: 13/740,130

(22) Filed: Jan. 11, 2013

Related U.S. Application Data
(63) Continuation-in-part of application No. 12/935,366, filed on Sep. 29, 2010.
(60) Provisional application No. 61/586,483, filed on Jan. 13, 2012.
(60) Provisional application No. 61/041,562, filed on Apr. 1, 2008.

(51) Int. Cl. G01N 15/14; G06F 15/00

(52) U.S. Cl. CPC G01N 15/1429; G06F 15/00
USPC 702/27; 702/19

(57) ABSTRACT

Systems, methods, and computer-readable media for determining parameters are provided, as are methods for determining differences in one or more biological response(s) by cell(s) to factor(s). Distances or difference scores are automatically calculated between test data and reference data from a flow cytometer.

### CROSS-REFERENCE TO RELATED APPLICATIONS (IF NECESSARY)

This application claims the benefit of U.S. Provisional Patent Application Ser. No. 61/586,483 (PRF docket 65938-01), filed Jan. 13, 2012 and entitled “Gate-free analytical method for flow cytometry,” the entirety of which is incorporated herein by reference; and is a continuation-in-part of U.S. application Ser. No. 12/935,366 (PRF docket 65093) filed on Feb. 29, 2010, which is a national stage entry of PCT/US2009/038995, filed Mar. 31, 2009, which claims the priority of provisional U.S. Application No. 61/041,562, filed Apr. 1, 2008 each of which is incorporated herein by reference in its entirety.

### FIELD OF THE INVENTION

The present application relates to data analysis, and specifically to analysis of data captured using flow cytometry techniques.

### BACKGROUND OF THE INVENTION

Flow cytometry is a useful technique for measuring properties of microscopic objects, such as cells, beads, or particles. Flow cytometry can also be used to measure biological responses of cells to stimuli, such as drug candidates. However, the analysis of cytometric data conventionally proceeds by gating. In this technique, a human operator manually selects criteria by which cells are subdivided into those that meet the criteria and those that do not. This technique is very time-consuming. Moreover, manually-gated analyses are not generally repeatable; two analysts working on the same data might choose to gate different variables in different orders, and would almost certainly not pick identical thresholds or criteria for any given variable.

Moreover, modern cytometric systems, such as the CyTOF®, produce extremely large volumes of data. For example, numerous different dosage levels of numerous drugs can be tested very rapidly, and numerous measurements can be taken for each drug, at each concentration. Bodenmiller describes an assay with 43 variables measured on each of approximately five million cells. Analyzing these data would require a small army of analysts. There is, therefore, a continuing need for improved ways of analyzing flow-cytometric data.

### BRIEF DESCRIPTION OF THE INVENTION

According to various aspects of the invention, there are provided systems and methods for automatically analyzing cytometric data without gating, e.g., without applying hard yes/no criteria to measured variables. Computer-readable media including instructions for performing such analyses are provided.

Various embodiments advantageously permit determining meaningful parameters from the measured values with no human intervention.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a schematic perspective of an exemplary flow cytometer;

FIG. 2 is a schematic top view of an exemplary flow-cytometry system for measuring wells on a plate;

FIG. 3 is a schematic of exemplary configurations of a plate;

FIG. 4 shows an example of a plate configuration;

FIG. 5 shows an example of a histogram of cytometric data;

FIG. 6A shows a simulated cytometry histogram;

FIG. 6B shows simulated dose-response data;

FIG. 6C shows simulated distance-metric data;

FIGS. 7A-7C shows examples of symbols and terminology used in representing analyses in this disclosure;

FIG. 8 shows an example of a gated analysis of measured data;

FIG. 9 shows an example of a gate-free analysis of the data used in FIG. 8;

FIG. 10 is a plot of response IC50 curves from the analysis in FIG. 8;

FIG. 11 is a plot of distance curves from the analysis in FIG. 10;

FIG. 12 is a plot of JC-1 curves from an exemplary gated analysis;

FIG. 13 is a plot of JC-1 curves from an exemplary gate-free analysis;

FIG. 14 shows plots of analyses of measured data;

FIG. 15 shows a system for determining a parameter according to various aspects;

FIG. 16 is a flowchart of ways of computing parameters according to various aspects;

FIG. 17 is a flowchart of ways of determining differences according to various aspects;

FIG. 18 is a high-level diagram showing a data-processing system and related components;

FIGS. 19-21 show historical examples of flow-cytometric analysis;

FIGS. 22-24 show examples of gated workflows in flow cytometry;

FIGS. 25-28 show historical improvements in cytometric-data tracking and handling;

FIG. 29 shows examples of histograms and scatterplots produced by prior flow-cytometric systems;

FIG. 30 shows an operational modality of flow-cytometric data analysis;

FIG. 31 shows a partly-schematic perspective of the optical design of a basic flow cytometer;

FIG. 32 shows an automated sampling system;

FIG. 33 shows representations of images of a flow cytometer and a HyperCyt™ robot;

FIG. 34 shows exemplary scatterplots of cytometric data;

FIG. 35 shows a representation of an experimental plate layout and results;

FIG. 36 shows chemical structures of example dyes and data corresponding to those dyes;

FIG. 37 shows a process of running a plate of samples;

FIG. 38 shows a representative screen capture of a software program for flow-cytometric data analysis (“PlateAnalyzer”);

FIG. 39 shows a portion of a screen capture of PlateAnalyzer;

FIG. 40 shows exemplary representations of cytometric data;

FIG. 41 shows a screen capture of a listing of FCS files;

FIG. 42 shows a representative screen capture of PlateAnalyzer;

FIGS. 43-45 shows representative screen captures of PlateAnalyzer;

FIG. 46 shows a representative screen capture of PlateAnalyzer;

FIG. 47 shows a representative IC50 curve;

FIG. 48 shows a representative data table;

FIGS. 49-52 show representative screen captures of PlateAnalyzer;

FIG. 53 shows an example of population areas in a scatterplot;

FIGS. 54 and 55 show examples of visualizations of flow-cytometry data;

FIGS. 56-57 show examples of cytometry histograms; and

FIG. 58 shows a graphical representation of a historical basis of cytometry analysis.

The attached drawings are for purposes of illustration and are not necessarily to scale.

### DETAILED DESCRIPTION OF THE INVENTION

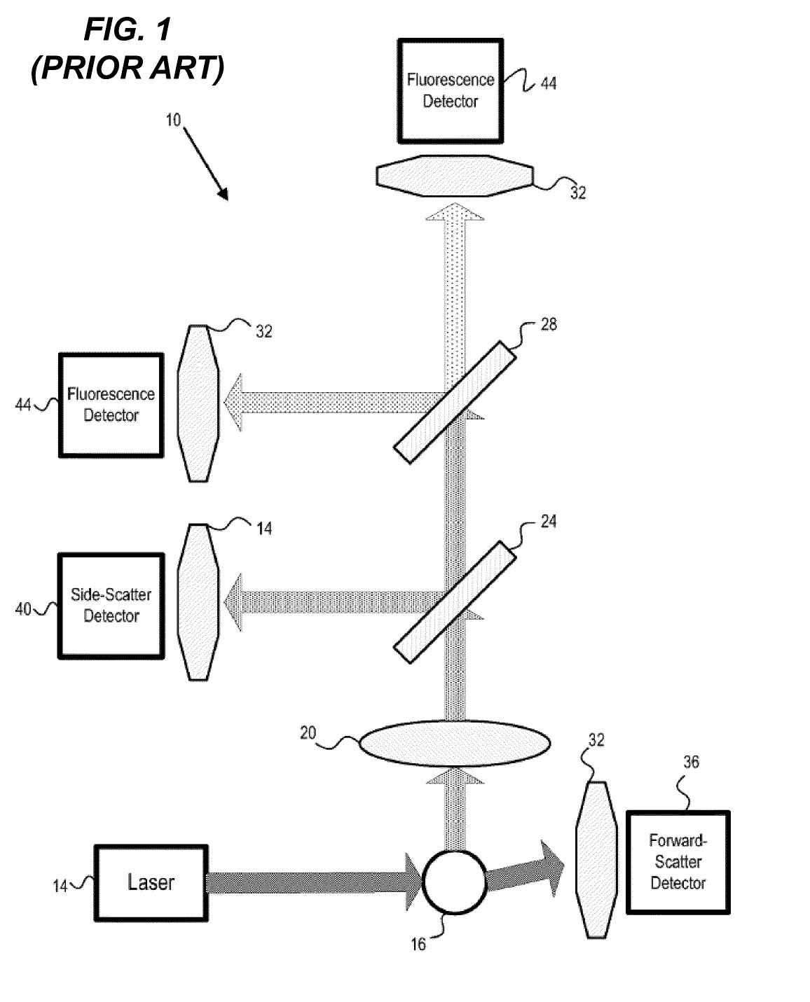

FIG. 1 is a schematic perspective of an exemplary flow cytometer. FIG. 1 is a flow diagram of a simplified, conventional flow cytometer 10. The flow cytometer 10 includes a laser 14, a flow cell 16, an optical system including a collection lens 20, a beam splitter 24, a dichroic mirror 28, and a number of optical filters 32. A dichroic mirror is used to reflect light selectively according to a specific wavelength. Accordingly, multiple dichroic mirrors 28 may be used to attempt to direct light of a specific wavelength. The flow cytometer 10 further includes detectors, including a forward-scatter detector 36, a side-scatter detector 40, one or more fluorescence detectors 44, and an absorbance detector (not shown). The absorbance detector, if included, would be aligned in line with the laser beam and would detect loss in axial light, indicating an absorbance thereof. An amplification system (not shown) may also be employed, wherein amplifiers are placed after the detectors to strengthen signals of detected scattered light or fluorescence.

The laser 14 emits excitation light, which is directed onto the flow cell 16, which includes a hydro-dynamically focused stream of fluid having the sample of interest. More specifically, the flow cell is a glass, quartz or a plastic piece of fluidic equipment enclosing a stream of sheath fluid, which carries particles. The point of impact of the laser beam within the flow cell 16 is referred to as the interrogation point. The excitation light can come from another source besides a laser. The light scattering and/or fluorescence emission occurs upon impact of the excitation light, which then passes through the optical system components listed above, depending on the wavelength corresponding to the individual photons that have been excited and their direction of travel.

The detectors listed above are aimed at the point where the fluid stream passes through the light beam; one in line with the light beam (Forward Scatter or FSC) 36, several perpendicular to it (Side Scatter (SSC) 40, and one or more fluorescence detectors 44). Each suspended particle (from 0.2 to 150 micrometers in diameter) passing through the beam scatters the light in some way, and fluorescent chemicals found in the particle or attached to the particle may be excited into emitting light at a longer wavelength than the light source. This combination of scattered (or transmitted) and fluorescent light is picked up by the detectors, wherein the scattered light is detected by the forward and side scatter detectors 36, 40 and the fluorescent light is detected by the fluorescence detectors 44.

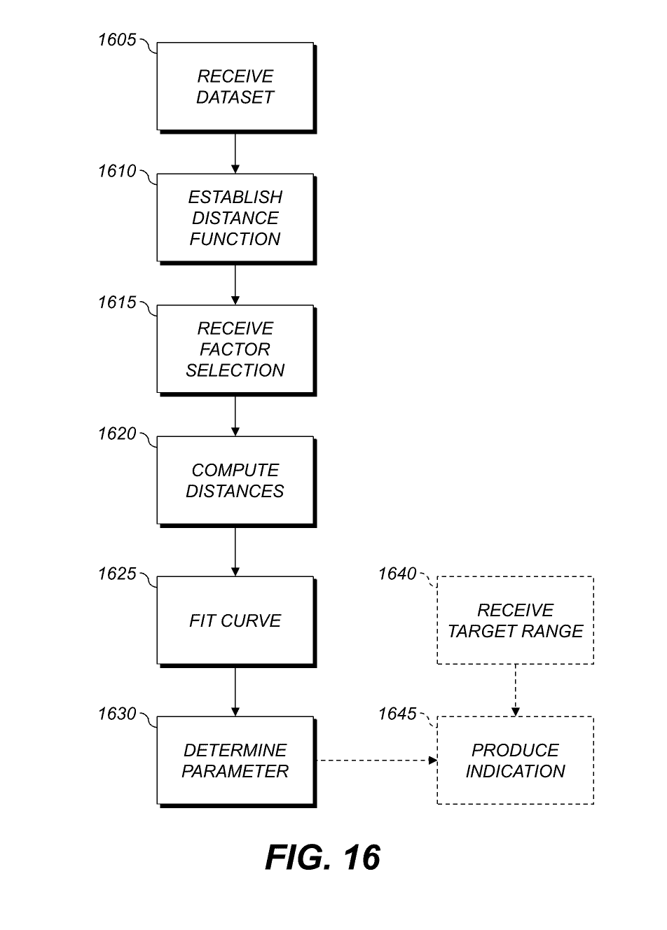

The detectors are connected to a computer (FIG. 16), which analyzes the intensity of the light incident at each detector. By analyzing intensity of light incident at each detector, it is then possible to derive various types of information about the physical and chemical structure of each individual particle of the fluid sample. For instance, FSC correlates with the cell volume and SSC depends on the inner complexity of the particle (i.e. shape of the nucleus, the amount and type of cytoplasmic granules or the membrane roughness).

Various aspects of flow cytometry systems include five main components:
(1) the flow cell, which includes a liquid stream (sheath fluid) to carry and align the particles so that they pass single file through the light beam for sensing;
(2) the optical system having illumination sources: lamps (mercury, xenon); high power water-cooled lasers (argon, krypton, dye laser); low power air-cooled lasers (argon (488 nm), red-HeNe (633 nm), green-HeNe, HeCd (UV)); diode lasers (blue, green, red, violet) resulting in light signals;
(3) the detectors (typically photomultipliers or avalanche photodiodes) and an Analog-to-Digital Conversion (ADC) system: converting FSC and SSC as well as fluorescence signals from light into electrical signals that can be processed by a computer;
(4) the amplification system: linear or logarithmic; and
(5) the computer for analysis of the signals. Early flow cytometers were generally experimental devices, but recent technological advances have created a considerable market for the instrumentation, as well as the reagents used in analysis, such as fluorescently-labeled antibodies, calibration beads, and analysis software.

Flow cytometric assays have been developed to determine both cellular characteristics such as size, membrane potential, and intracellular pH, and the levels of cellular components such as DNA, protein, and surface receptors. Measurements in flow cytometry are presented for further interpretation and analysis as distributions of parameters measured in population of cells.

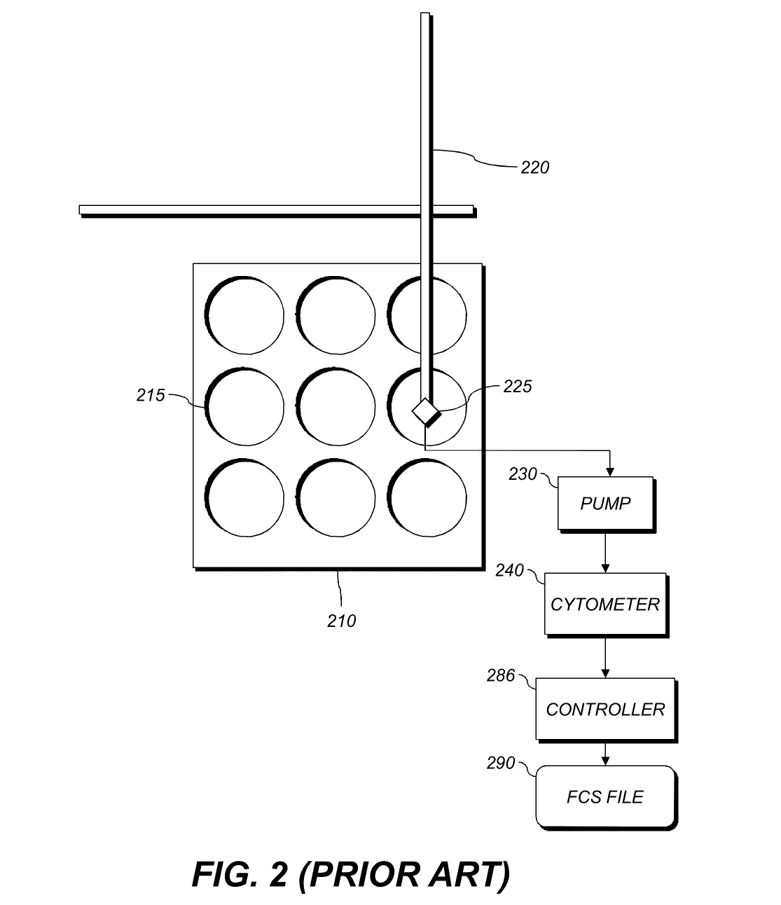

FIG. 2 is a schematic top view of an exemplary flow-cytometry system for measuring wells 215 (circles; only one is labeled) of sample plate 210. Each well holds a quantity of liquid, e.g., a buffer solution with a cell population therein. Stage 220 positions sampling probe 225 (a tube, but represented graphically here as a diamond) over a well. Stage 220 or probe 225 includes a Z-axis motion drive to dip the tip of probe 225 into the liquid in well 215 and subsequently retract that tip from that liquid. Pump 230 draws fluid out of the well through sampling probe 225 and passes the liquid to flow cytometer 240. This permits automatically sampling successive wells 215 by successively dipping sampling probe 225 in each well and passing the liquid to cytometer 240. Cytometer 240, or controller 286 attached thereto, can produce a data file recording the measured values of the variables (e.g., forward scatter or side scatter, discussed above). For example, this can be FCS file 290. FCS file 290 can include the Tube Identification Parameter (TIP) that identifies from which well 215 the measured cells were taken, and a time at which the measurement was taken.

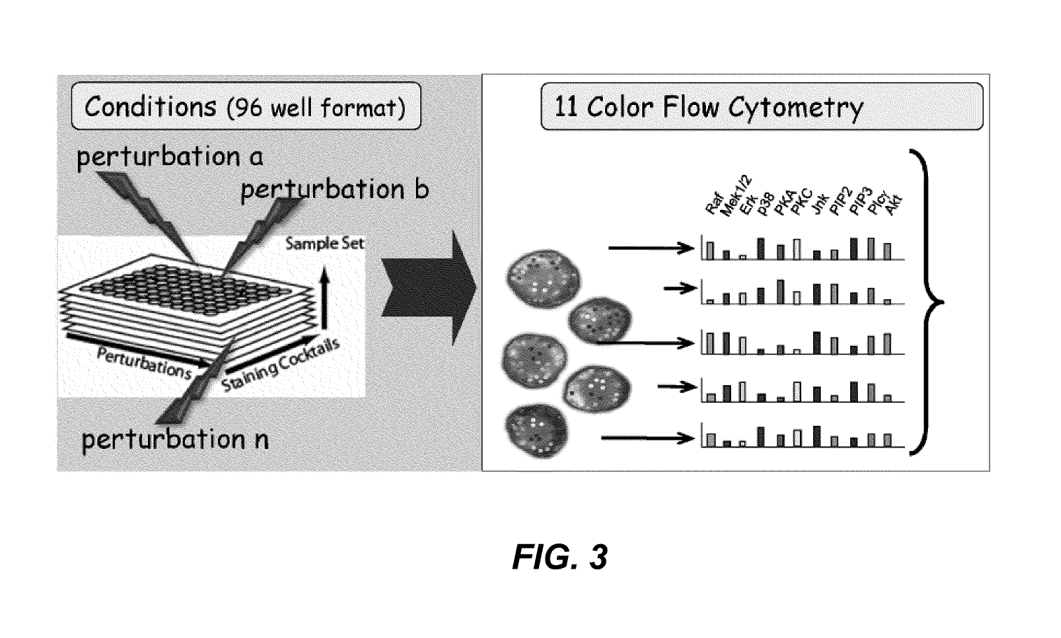

FIG. 3 is a schematic of exemplary configurations of a plate. “Conditions” shows a plurality of plates (“sample set”), each of which has wells corresponding to “perturbations” and “staining cocktails.” “Perturbations” are also referred to herein as “factors” or “sets of factors,” according to context. The perturbations, e.g., perturbations “a”, “b”, and “n”, are substances. This configuration permits testing the effects of those substances on cells in the wells. The staining cocktails include, e.g., specific fluorescent dyes that will make specific cellular responses, properties, or conditions visible to a flow cytometer. In an example, the cocktails include antibodies conjugated to fluorescent molecules. If the antibodies bind to antigens in the cells under test, they will express the fluorescence under flow cytometry. In another example, the cocktails include substances such as calcein or JC-1 (discussed herein) that express fluorescence depending on the state of a biological system or process. This permits determining whether the system is operational (e.g., a live cell) or the process is being carried out based on the measured intensity of fluorescence. Examples of staining cocktails are shown on the right, under “11 Color Flow Cytometry”: Raf, Mek1/2, Erk, p38, PKA, PKC, Jnk, PIP2, PIP3, Plcγ, and Akt. As shown in the simulated example on the right, different cells (in this example, primary human T-cells) express different intensities of fluorescence of the different staining cocktails.

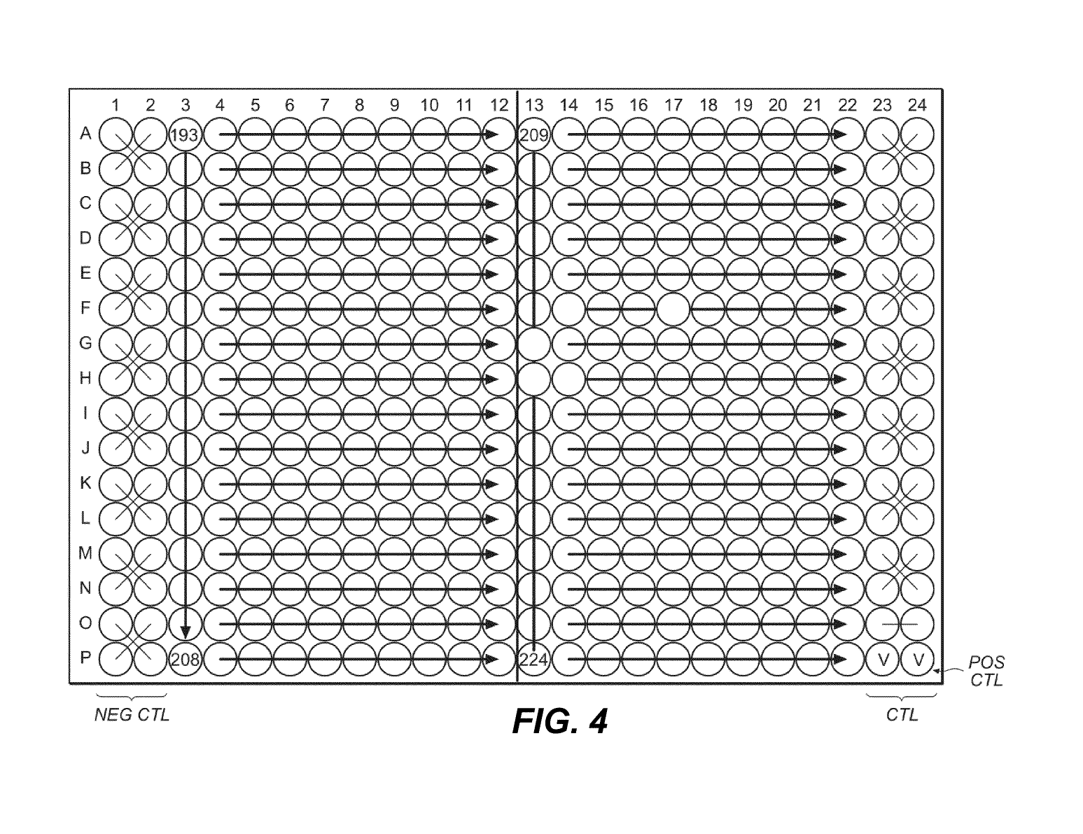

FIG. 4 shows an example of a plate configuration. The plate has wells in rows A-P and columns 1-24. Columns 1, 2, 23, and 24 have no compounds (perturbations) in them. Columns 1 and 2 are entirely negative controls. Columns 23 and 24 rows A-O are also negative controls; cols. 23-24 of row P are positive controls. Negative controls exhibit responses characteristic of the lack of an effect by a perturbation on cells. Positive controls exhibit responses characteristic of the presence of an effect by a perturbation on cells. In an example, calcein is used. Calcein is a fluorescent dye that can pass through cell membranes. Interactions with the normal physiology of living cells cause the calcein to become fluorescent. However, in cells that are dead or dying, the calcein does not become fluorescent. In this way, calcein is correlated with cell viability. In this example, a suitable negative control would b dead cells, e.g., killed by a toxin deliberately applied. A suitable positive control would be live cells, e.g., those to which the toxin was not applied. The concentration of toxin is high for a negative control and low for a positive control. In another example, propidum iodide is used; it dyes (“stains”) dead or compromised cells. Other examples of biological systems that can be tested include mitochondria, which can be tested for normal function. Compromised mitochondria can lead to reduced muscle function, possibly including heart attack. Normal vs. abnormal membrane potential of mitochondria can be tested.

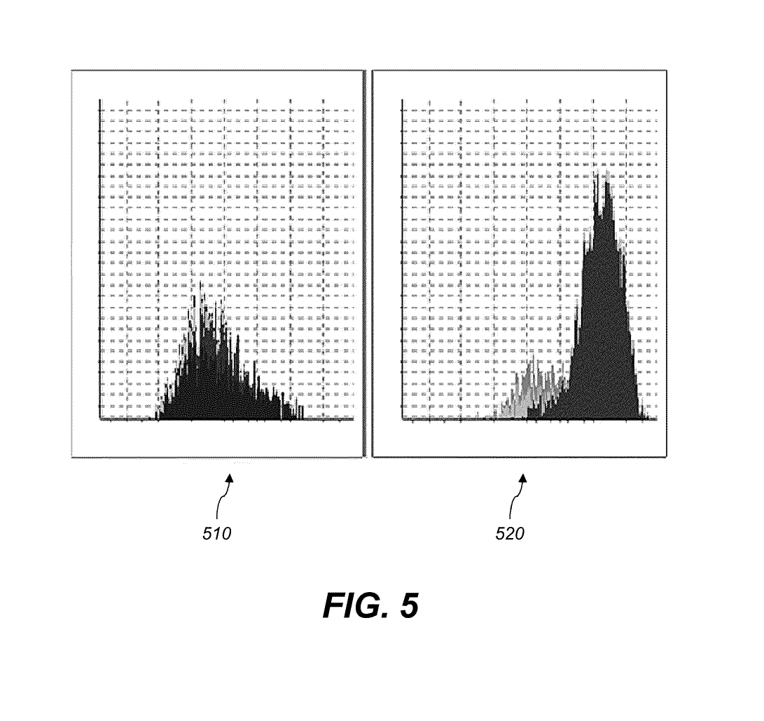

FIG. 5 shows examples of histograms of cytometric data. The X-axis is the logarithm of measured intensity of calcein fluorescence, and the Y axis is the number of fluorescence events at that intensity detected by the flow cytometer. As can be seen, the cells represented in histogram 510 had generally lower intensities of calcein fluorescence than the cells represented in histogram 520. Linear X-axis scales, modified log scales, or hyperbolic arc-sine (asinh) scales, or other scales appropriate to the experiment can also be used. The scale preferably gives each range of data an appropriate range of the plot. In general, labels or stains used in flow cytometry (e.g., calcein) are correlated with biological functions. The density of staining (correlated with the intensity of fluorescence) indicates whether the biological function is present, or to what extent it is compromised.

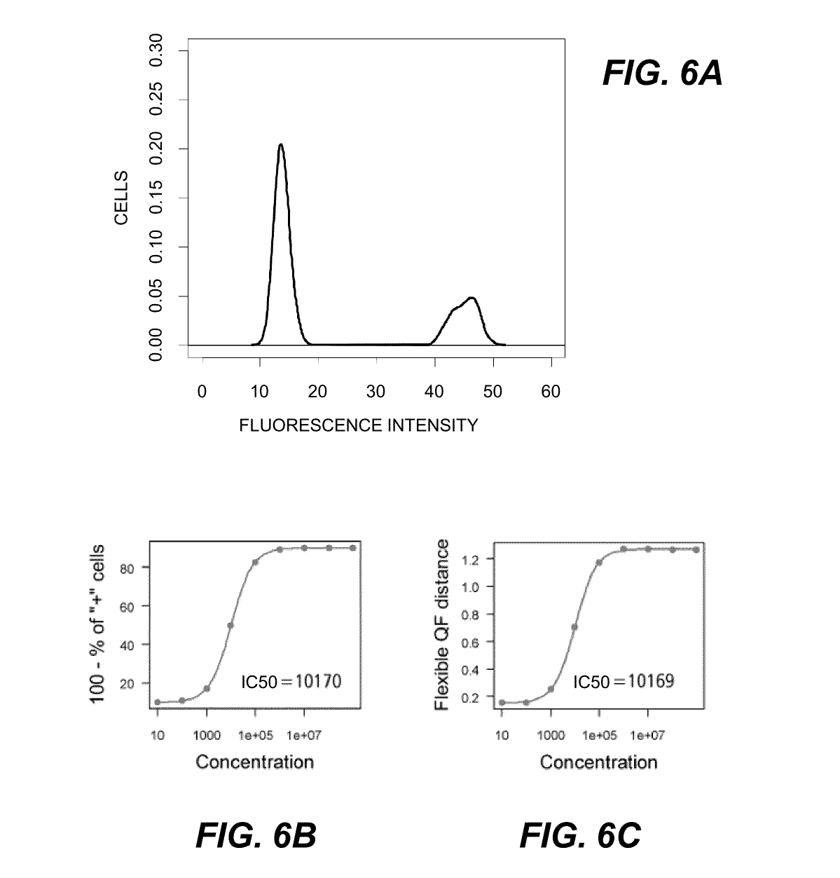

FIGS. 6A-6C shows simulated cytometry data, the corresponding dose-response data and the corresponding distance-metric data, respectively. FIG. 6A shows a simulated histogram with fluorescence intensity in arbitrary units on X and the percentage of simulated cells having that fluorescence intensity on Y. In this example, the data are an in silico mixture of an exemplary negative control and an exemplary positive control. For example, the controls could be calcein, with low intensities representing dead cells and high intensities representing live cells. Some cells in the simulation are negative (dead) and some are positive (live), so the histogram has two modes (peaks). Counting the number of cells under each mode permits determining what percentage of cells is alive or dead. FIG. 6B shows those percentages for various simulated mixtures of simulated live cells and simulated dead cells. The conventional “gating” technique involves applying a threshold, e.g., at intensity 30, to separate the live cells from the dead cells. In more than one dimension, gating is selecting or eliminating one or more modes of the n-d histogram from the population to be analyzed.

FIGS. 6B and 6C show response curves calculated from the data underlying FIG. 6A. These curves indicating the response of the simulated cells to various concentrations of a perturbation, e.g., a drug being tested for toxicity (if the drug kills the cells, they will not express calcein fluorescence as strongly). The abscissas are concentration of a perturbation. The ordinate in FIG. 6B is the percentage of cells with a response corresponding to the positive control. The ordinate in FIG. 6C is a flexible quadratic form (QF) distance metric between the measured population and the positive controls. Dots are simulated points and lines are best-fit sigmoid curves through those points. Dose-response curves can be scaled according to the measured response on a linear or log scale. For some dyes, e.g., JC-1, the relevant variable is color of fluorescence rather than amount of fluorescence (see discussion of JC-1 below). In various aspects using such dyes, the ratio of the fluorescence intensities of the two colors can be taken. The mean of the ratios of all cells in a particular well (a particular combination of factors) can be calculated and plotted in dose-response form.

The computed response curves of FIGS. 6B and 6C permit determination of IC50 or EC50. IC50 is the “half maximal inhibitory concentration,” i.e., a measure of the effectiveness of a compound in inhibiting biological or biochemical function. In this example, IC50 is the concentration at which half of the cells display a response corresponding to the positive control, where positive control produces maximal inhibition. IC50 is determined in FIG. 6B by determining the concentration at which the simulated curve has a value of 0.5. IC50 is commonly used as a measure of antagonist drug potency in pharmacological research. Similarly, for agonist drugs, EC50 (“half maximal effective concentration”) indicates the concentration of a compound which induces a response halfway between the baseline and the possible maximum. In this example EC50 would be calculated if the positive control produced maximal agonistic effect.

Although gating can be used to determine IC50 or EC50, as shown in FIG. 6B, each concentration of a drug results in a mixture of live and dead cells. Due to normal biological and instrument variation, the peaks of the histograms drift and overlap. As a result, a gate (e.g., intensity=30) selected with reference to a particular dataset (e.g., FIG. 6A) is not necessarily correct for other datasets. This challenge is even more severe, e.g., during drug screening, when drugs may have unexpected effects that confound simple gates.

Some schemes use automated gating performed by a computer, but this technique is complex. Moreover, automated gating has the same performance limitations as manual gating because of natural variability in the populations measured. Some schemes use clustering rather than fixed thresholds to divide cells so that percentages can be calculated and used to determine IC50. Other schemes can be used to divide cells into sub-populations, such as Gaussian-mixture analysis and flexible mixture models or Bayesian finite mixture models. However, automated gating is difficult to perform, and it is difficult to determine boundaries between clusters or subpopulations that accurately reflect underlying differences in the biological populations being measured.

Furthermore, most automated gating schemes are heuristic and produce multiple, equally-probable choices. An expert (human or software) has to select the appropriate end result. As with manual gating, clustering automated gating requires human input (directly or via an expert system) to make a decision: is this particular automated gating scheme producing the expected result? With gated techniques, the operator applies external biological constraints to provide sensible results. No matter how gating is done, gating involves some version of supervised or unsupervised classification applied to for each cell, restricting the analytical power of any gated analysis.

Instead of manual gating or automated gating, various aspects describe herein gate-free analysis in which a distance is computed between the measurement and a reference. An example of simulated results of such an analysis is shown in FIG. 6C. For example, the intensity distribution of calcein fluorescence from untreated cells (live cells) can be compared to an intensity distribution from treated (perturbed) cells. This technique involves computation of a distance function and does not require human input to select any gates (no gates are selected). Moreover, this technique can make comparisons (compute distances) in spaces of any number of dimensions. Whereas conventional gating operates typically on only two variables at a time (the most that can be presented conveniently to a human operator on a 2-D display screen), distances can be computed in spaces of any dimensionality. Computing distances is part of methods referred to herein as “gate-free analysis.” Moreover, results are not affected by sequence of gates as they might be in gated analysis.

In an example of gate-free analysis, IC50 or EC50 can be determined from QF distances instead of from gated cell percentages. QF distances with a best-fit sigmoid are used in various aspects to provide reasonable robustness in the face of biological variability expressed in the measured dataset. Specifically, the inflection point of the best-fit sigmoid is located; the concentration (abscissa value) at which that inflection point occurs is determined to be the IC50. In this example, the estimate of IC50 obtained from the QF distance is almost equal to the estimate of IC50 determined via gating. This indicates that distance metrics, such as QF, can be used to determine biologically meaningful results. The two IC50 values are not exactly equal because many cells involved in the distance calculation are not involved in the gated calculation. Using these cells has the effect that gate-free analysis with a given metric provides consistent results.

Depending on the system under test and the variables investigated, different IC50 values are computed. In an example, the IC50 for a particular drug with respect to mitochondrial function (e.g., JC-1 dye) is less than the IC50 for that drug with calcein. This IC50 relationship indicates that the particular drug damages mitochondria or inhibits mitochondrial function at a lower dosage than the dosage at which that drug actually kills the affected cells.

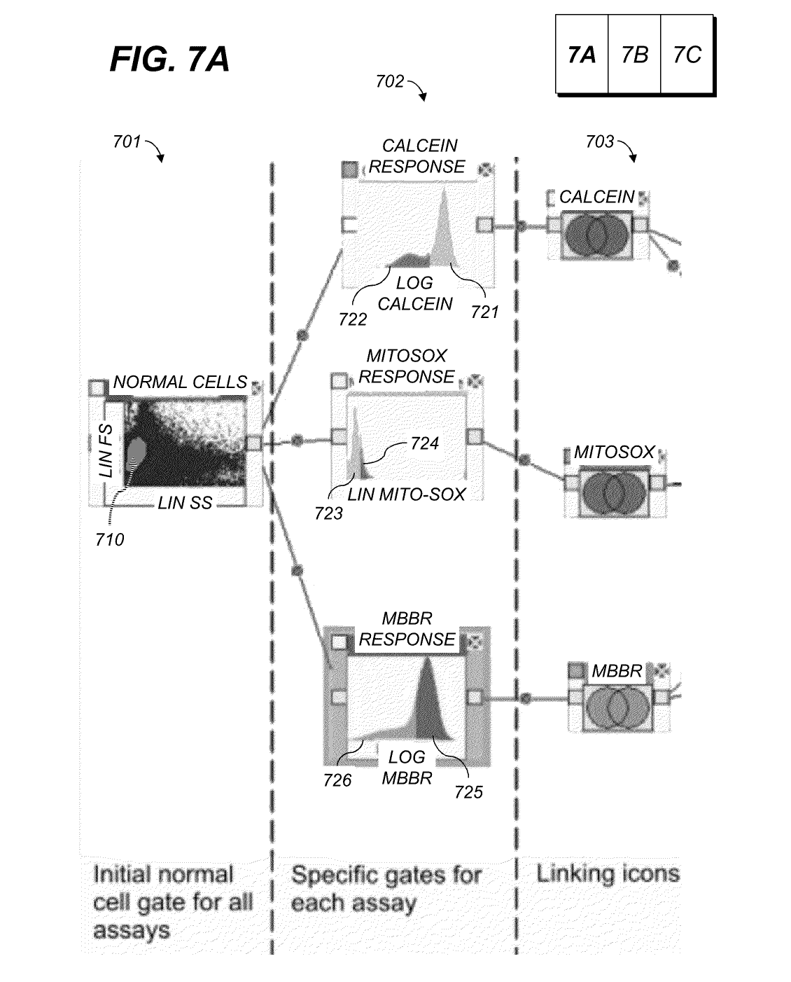

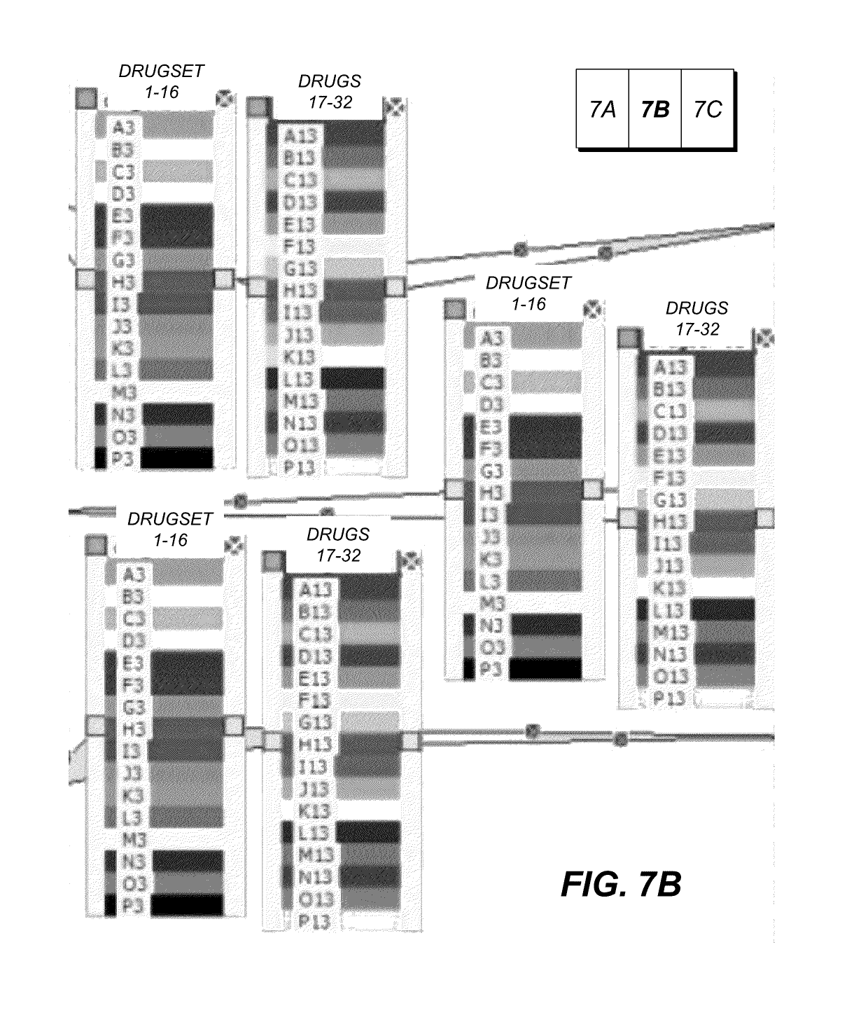

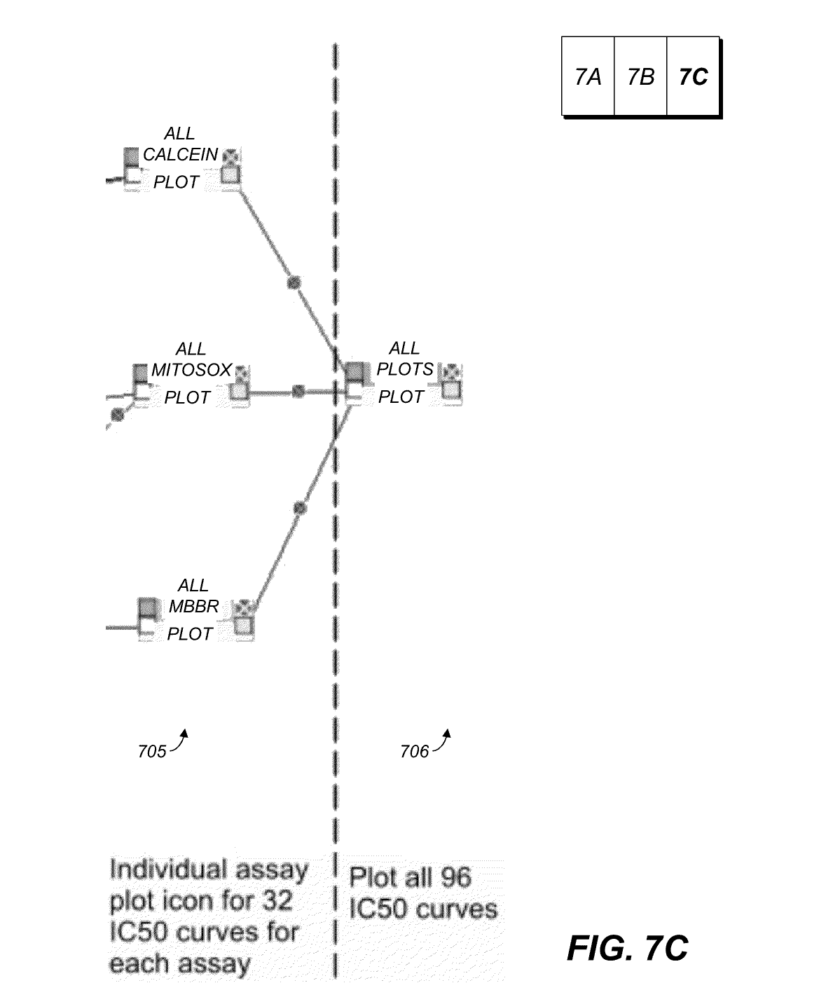

FIGS. 7A through 7C show examples of symbols and terminology used in representing analyses in this disclosure. These examples, and corresponding symbols when used throughout this disclosure, are of a dataflow graph with edges connecting functions to carry data from left to right. Data flows from FIG. 7A through FIG. 7B to FIG. 7C.

Referring to FIG. 7A, column 701 shows a scatterplot of side-scatter measurements (LIN SS) vs. forward-scatter measurements (LIN FS) of an exemplary measured data set. Gating region 710 is shown highlighted; cells in region 710 match the desired conditions. The lead line for region 710 is shown hatched for clarity, since the data across which lead line 710 travels is represented darkly. Gating region 710 is selected to define the condition to be tested. For example, when testing a particular concentration of a drug, cells exposed to that drug at that concentration are considered. Of those cells, those that have measurements falling within the gated region are counted. The percentage which the counted cells make of the total number of cells considered is used to determine parameters of the interaction between the cells and the drug, as discussed above with reference to FIG. 7.

Column 702 shows histograms of measured data from the cell population shown in column 701. Three variables are shown: calcein, MitoSOX™, and monobromobimane (mBBr). Histogram portions 721, 723, 725 show the portion of the cells inside gating region 710, and histogram portions 722, 724, 726 show the portion of the cells outside gating region 710.

Column 703 shows “linking icons”, here with filled-in intersecting circles to indicate that a set union is being performed, i.e., all measurements are being retained.

FIG. 7B shows “drug box” icons. Each box represents 16 drugs at ten different dosage levels. The drug boxes are labeled with the wells (e.g., “A3”) in which the relevant data are found, and each row of each drug box represents a ten-point dose-response curve of a different drug. The labels in the drug boxes, e.g., “A3”, identify the first well of a sequence of dosage levels. The other dosage levels are in wells arranged in a selected relationship to the identified wells, e.g., A4-A11 for identified well A3. No particular arrangement of wells is required; wells of a sequence can be adjacent or not,

FIG. 7C shows PLOT boxes. In the examples below, lines connected to the left sides of PLOT boxes cause corresponding plots to be generated. For example, in column 705, the PLOT boxes cause IC50 curves (as the percentage of cells within gating region 710) to be generated for the corresponding variable (calcein, MitoSOX™, or mBBr). Those plots can be overlaid (column 706).

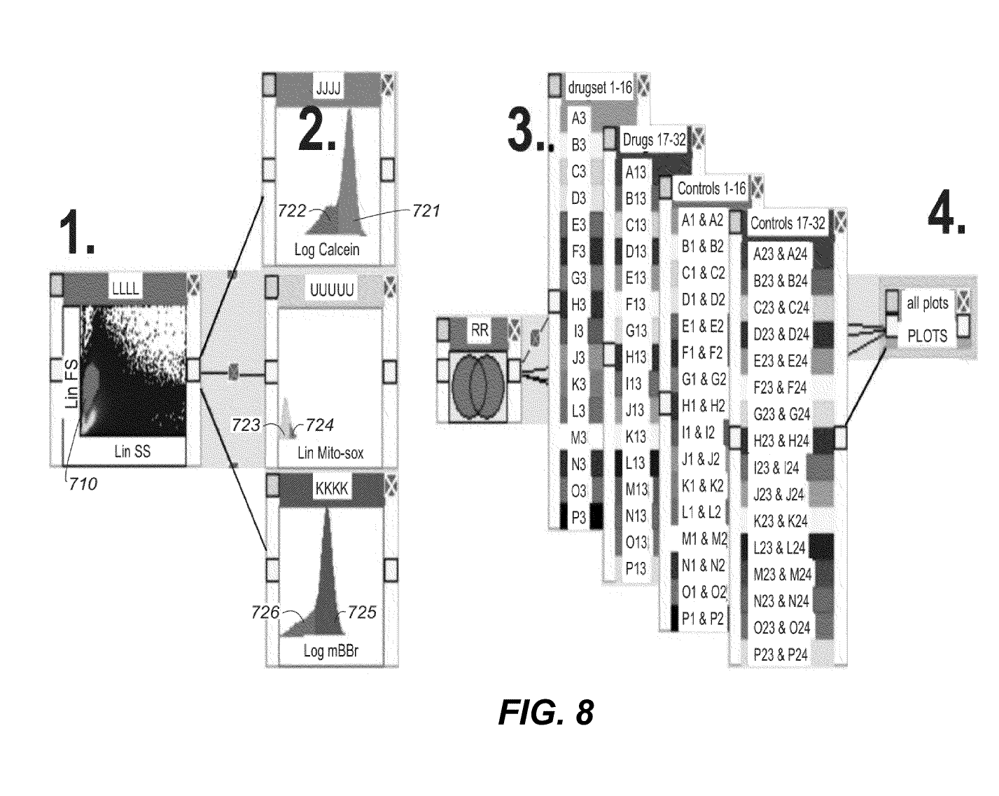

FIG. 8 shows an example of a gated analysis on measured data. This is the analysis of FIG. 7, shown together in one figure. Gated region 710 includes the cells in histogram portions 721, 723, 725; other cells are in histogram portions 722, 724, 726.

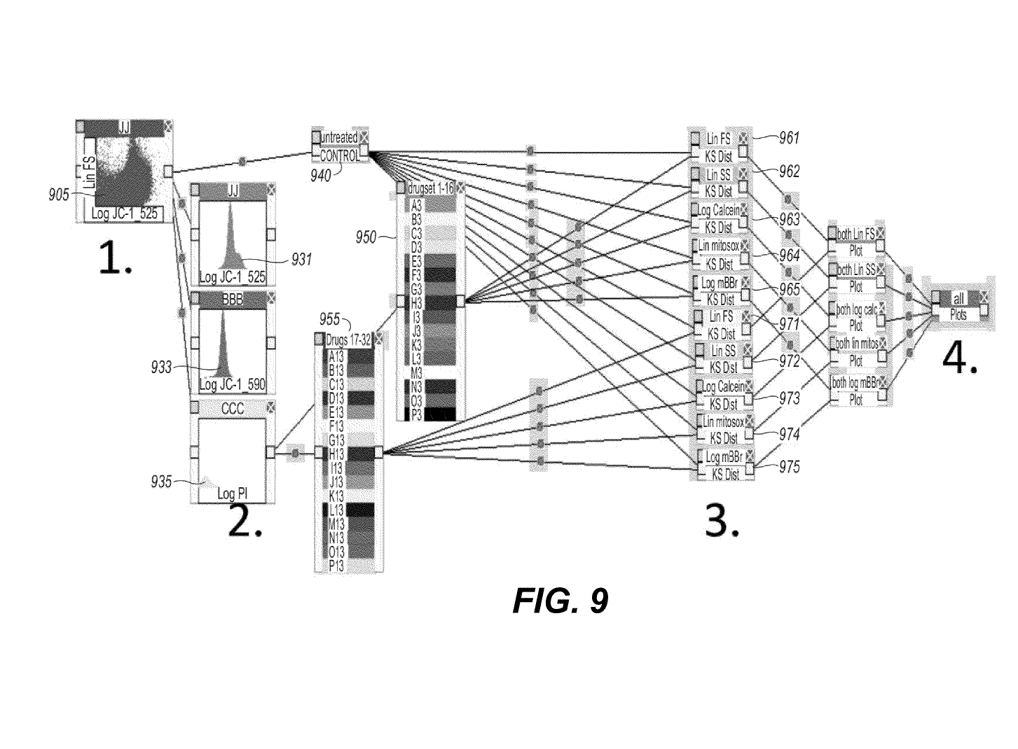

FIG. 9 shows an example of a gate-free analysis of the data used in FIG. 8. Population 905 is not gated, as can be seen by the absence of visible gating regions in population 905. Moreover, histograms 931, 933, 935 are not divided into histogram portions. All the data for population 905 are used, not merely data included in a gating region. Histogram 931 shows JC-1 at 525 nm, histogram 933 shows JC-1 at 590 nm, and histogram 935 shows PI.

Control box 940 is a reference, which can be an untreated control. That is, the outputs of drug box 940 can be data from those cells in wells exposed to desired perturbants, or from those cells in control wells. Drug boxes 950, 955 select wells containing drugs 1-16 (box 950) and drugs 17-32 (box 955), each in a ten-step dilution sequence. The outputs of each drug box are then compared to the control for a variety of variables. Distance boxes 961, 962, 963, 964, 965 compare drugs 1-16 from drug box 950 to controls from control box 940. Distance boxes 971, 972, 973, 974, 975 compare drugs 17-32 from drug box 955 to controls from control box 940. Distance boxes 961, 971 compute the KS distance with respect to forward-scatter data, on a linear scale. Distance boxes 962, 972 compute the distance with respect to side-scatter data, on a linear scale. Distance boxes 963, 973 compute the distance with respect to calcein data, on a logarithmic scale. Distance boxes 964, 974 compute the distance with respect to MitoSOX™ data, on a linear scale. Distance boxes 965, 975 compute the distance with respect to mBBr data, on a log scale. In this example, each distance box 961, 962, 963, 964, 965, 971, 972, 973, 974, 975 computes the distance using KS, but QF, earth-mover's distance, KL, symmetrized KL, or other metrics can be used. The resulting distances are plotted (“4.”).

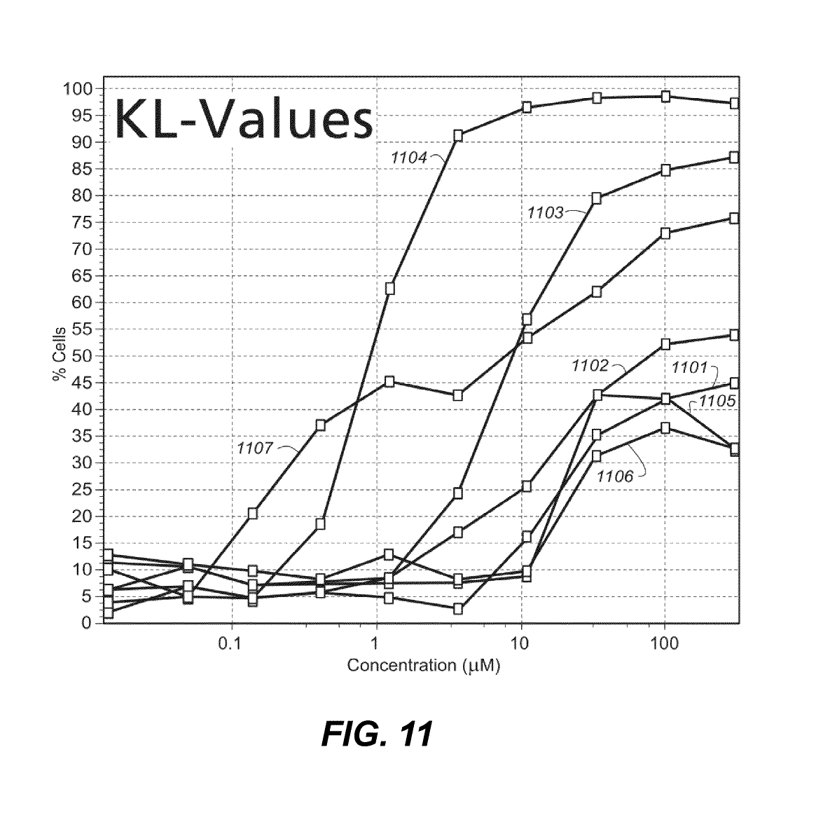

The computed distances represent how close each population (e.g., those cells exposed to drug A3) is to the reference (e.g., a control). Examples of the computed distances are given below with reference to FIG. 11.

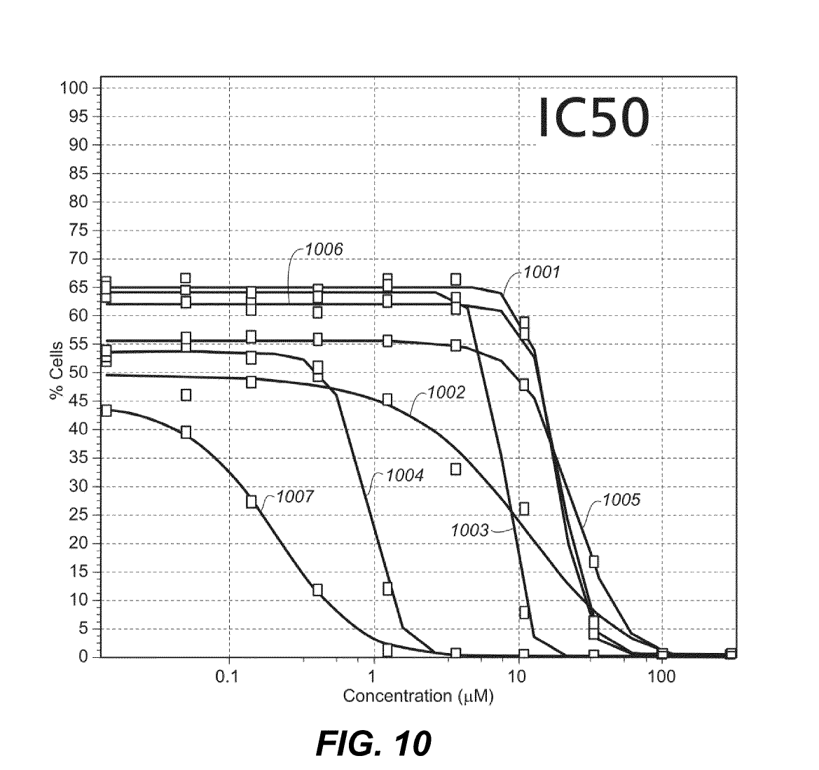

FIG. 10 is a plot of IC50 curves from the analysis in FIG. 8. This is a gated analysis. The abscissa is concentration (μM) and the ordinate is the percent of considered cells falling in the gated region. Where each curve passes through the point on the ordinate halfway between the lowest ordinate value and the highest ordinate value for that curve indicates the IC50 for that condition. Response curves for multiple drugs are plotted.

FIG. 11 is a plot of distance curves from the analysis in FIG. 10. The abscissa is concentration in μM and the ordinate is distance. This is the gate-free analysis. Response curves for multiple drugs are plotted. IC50 values can be determined as the inflection points of sigmoidal curves fitted to the points. Curves 1101, 1102, 1103, 1104, 1105, 1106, 1107 correspond to FIG. 10 curves 1001, 1002, 1003, 1004, 1005, 1006, 1007 respectively. As can be seen, the inflection point of each curve on FIG. 11 approximates the 50% point of the corresponding curve on FIG. 10.

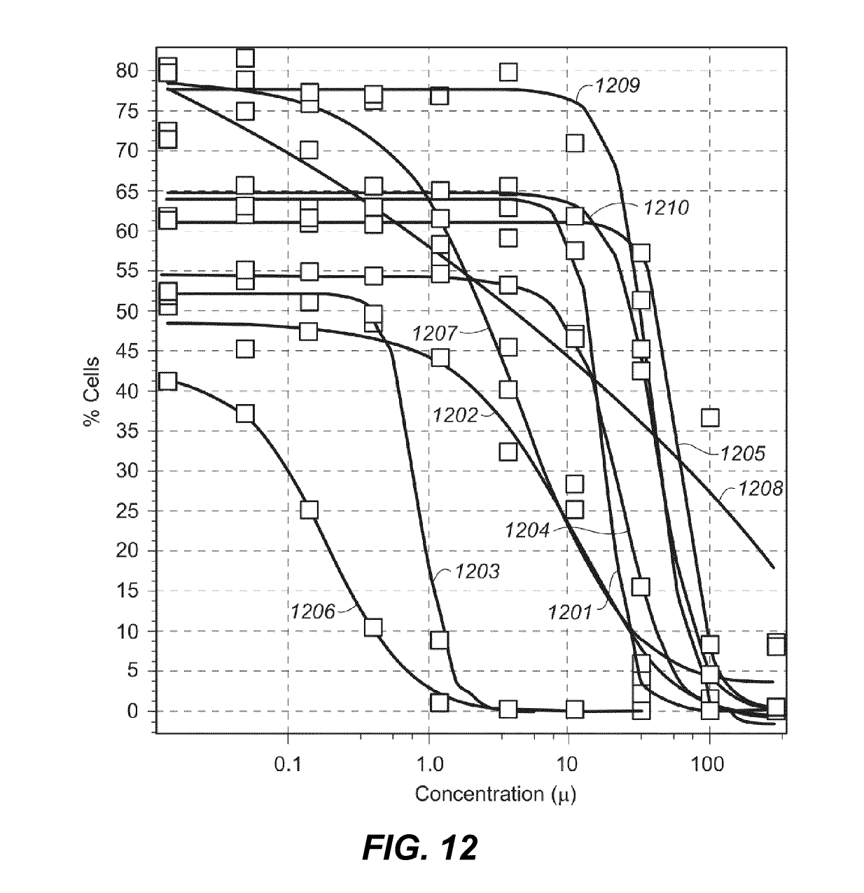

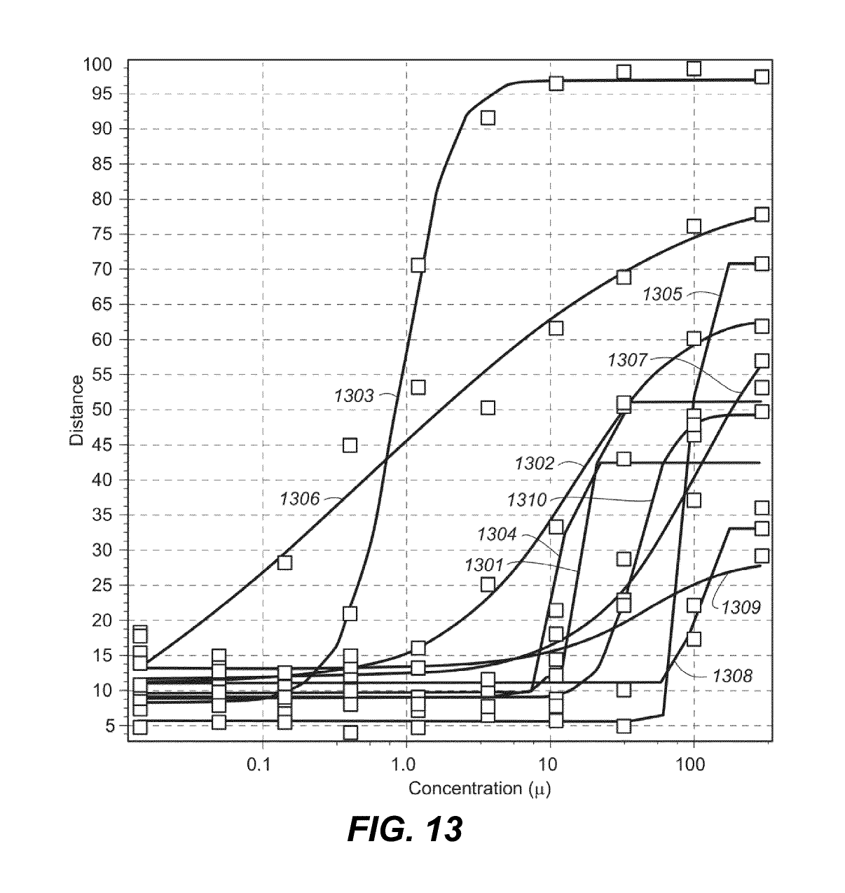

FIG. 12 is a plot of JC-1 curves from an exemplary gated analysis and FIG. 13 is a plot of JC-1 curves from an exemplary gate-free analysis. Both analyses are of the same measured data. JC-1 is MITOPROBE JC-1, a label by INVITROGEN that indicates mitochondrial health. JC-1 accumulates in mitochondria to an extent dependent on the potential across the mitochondrial membrane, and the color of fluorescence of the JC-1 depends on its concentration within a given mitochondrion. Specifically, accumulation in the mitochondrion is indicated by a shift in fluorescence emission from green (˜529 nm) towards red (˜590 nm). Consequently, mitochondrial depolarization is indicated by a decrease in the ratio of red fluorescence intensity to green fluorescence intensity. The mitochondrial IC50 determined from JC-1 measurements is a point at which 50% of the measured cells have compromised mitochondrial function, as indicated by their mitochondrial membrane potentials and as expressed by the intensity of fluorescence of JC-1 at a particular color (e.g., 525 nm or 590 nm).

The abscissas in FIGS. 12 and 13 are log of concentration. The ordinates are percent of cells (FIG. 12) and value of a distance function (FIG. 13). The IC50 values determined from these analyses are tabulated in Table 1. There is one curve for each condition. Each condition is exposure to a particular drug. The responses of cells to various concentrations of each condition (drug) were measured. A condition is also referred to herein as a “modifying factor;” a concentration is also referred to herein as a “series factor.” “Condition” matches the last two digits of the curve number: condition 1 corresponds to curve 1201 (FIG. 12) and curve 1301 (FIG. 13), and likewise through condition 10, curves 1210 and 1310. These IC50 values are for JC-1. The curves were determined by fitting a sigmoid to measured points corresponding to various concentrations. As discussed above, each point in the JC-1 curve for the gate-free analysis (FIG. 13) is a single computed metric distance. The curve is formed by fitting to a plurality of distances calculated for cells exposed to respective concentrations of a test drug.

TABLE 1

| Condition | IC50 (gated; FIG. 12) | IC50 (gate-free; FIG. 13) |
|---|---|---|
| 01 | 18 | 17.55 |
| 02 | 9.874 | 12.8 |
| 03 | 0.8478 | 0.8791 |
| 04 | 23.67 | 11.81 |
| 05 | 64.83 | 95.37 |
| 06 | 0.1855 | 0.1091 |
| 07 | 3.923 | 96.16 |
| 08 | >100 | 108.7 |
| 09 | 40.95 | 42.34 |
| 10 | 44.23 | 40.62 |

Except for condition 07, the gate-free values (FIG. 13) are of the same order of magnitude as the gated values (FIG. 12). Since the abscissa is the logarithm of concentration, even the absolute difference between the IC50 values for condition 05 is not necessarily unreasonable. These data show that gate-free IC50 values can be used to determine biologically- or clinically-relevant parameters such as IC50.

In this way, parameters like toxicity can be expressed in terms of distances rather than in terms of a percent of a cell population. This permits automating initial screens for new drugs. This technique is also reproducible, which permits readily reproducing analyses for audit or historical purposes. Gate-free analysis does not require any analytical decision-making by a human; for a particular experiment, an analyst can readily obtain parameter values from a gate-free analysis.

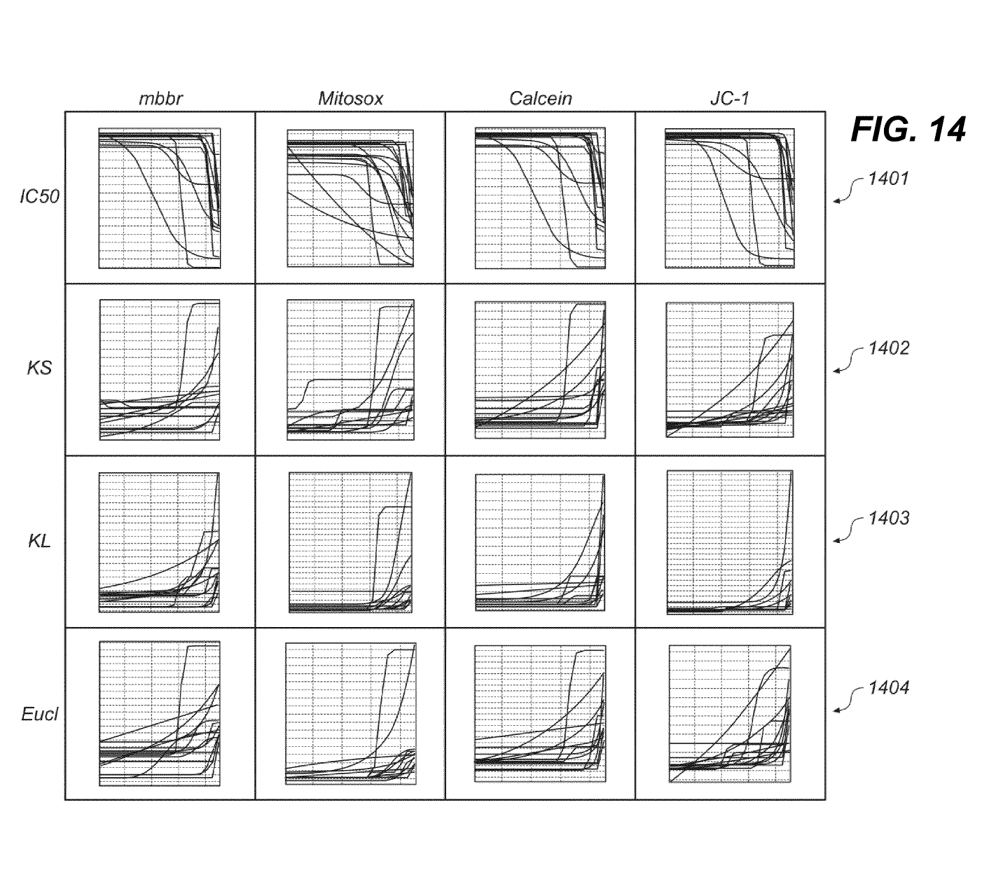

FIG. 14 shows plots of various analyses of measured data. Row 1401 shows IC50 data from gated analyses. Row 1402 shows KS distances, row 1403 shows KL divergences, and row 1404 shows Euclidean distances. The columns from left to right are mBBr, MitoSOX™, calcein, and JC-1.

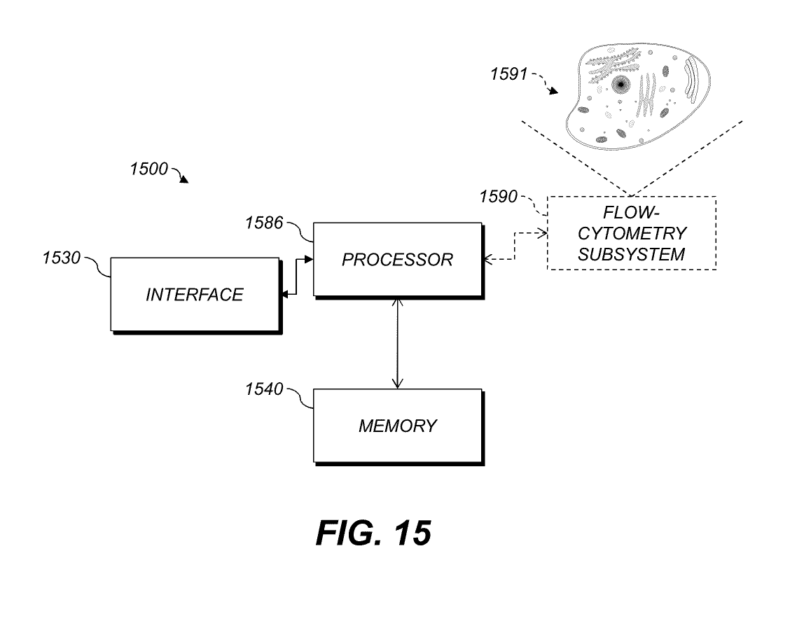

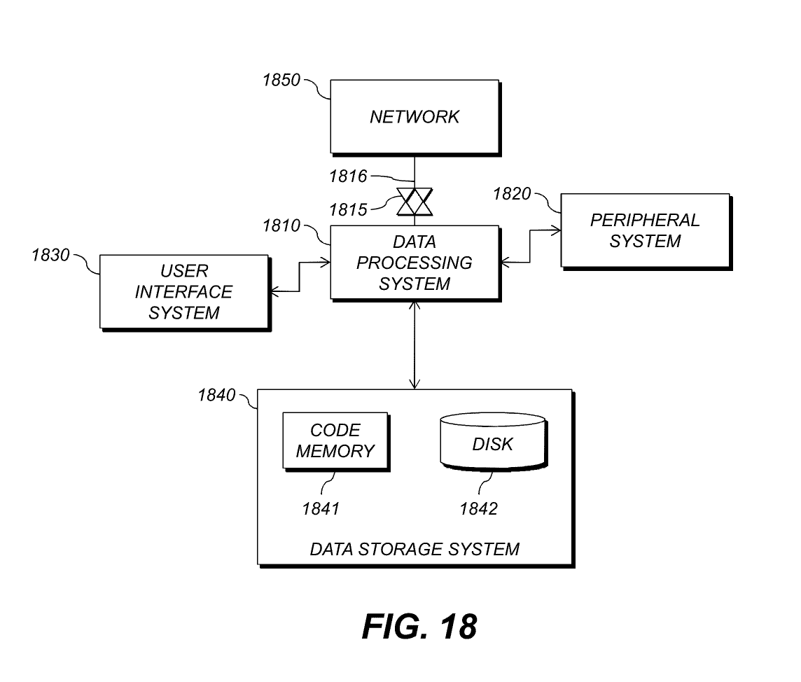

FIG. 15 shows parameter-determining system 1500 for determining a parameter of a system under test from flow cytometry data according to various aspects. The system under test can be a biological system or another system, e.g., a chemical system. In system 1500, processor 1586 is communicatively connected with memory 1540 and interface 1530 and optionally with flow-cytometry subsystem 1590. Subsystem 1590 measures system under test 1591 (which can be biological, chemical, or other). Subsystem 1590, when used, is adapted to produce the measured data set and provide it to the memory (either directly or via processor 1586 or a different processor) to be stored. Subsystem 1590 can include a flow cytometer, a sampling robot, or other components such as those discussed above with reference to FIG. 2. Examples of components useful for interface 1530, processor 1586, and memory 1540 are discussed below with reference to FIG. 18.

Memory 1540 is adapted to store a measured dataset of the flow cytometry data. The measured dataset is organized according to at least a plurality of first factors and a plurality of second factors. Examples of factors include drug type, drug dosage, or activation-molecule type. Any number of factors >1 can be used in each plurality, and any number >1 of pluralities of factors can be used (e.g., one first plurality and one second plurality). The measured dataset includes measurement(s) of one or more variable(s) for each of a plurality of combinations of one of the plurality of first factors with one of the plurality of second factors. The plurality of combinations can be, e.g., different wells, and the dataset can include respective measurements for each of one or more wells on a test plate. A full-factorial dataset can be used and include all possible combinations of a first factor with a second factor, or only a subset of possible combinations can be used. The variables can be, e.g., FS, SS, calcein, MitoSOX™, mBBr, or other variables as described herein.

Processor 1586 is adapted to receive indication(s) of first-control data and second-control data in the measured dataset. For example, the processor can execute stored-program instructions causing it to await receipt of the indication(s). In an example, the processor receives, via a command-line or graphical interface, an operator selection of which wells are positive controls and which are negative controls. In another example, the processor receives barcode or other identifying information from memory 1590. The controls can be positive and negative controls, e.g., calcein with dead cells and calcein with live cells, as discussed above. The indication identifies which data are controls, e.g., by specific tube identification parameters (TIP). The controller retrieves the first-control data and the second-control data from the stored measured dataset in the memory. Retrievals from memory of this and other data can be done in any order and at any time, and do not need to be done all at once. Data can be operated on in series or parallel, using a single-threaded, multithreaded, multicore, hyperthreaded, or other computation architecture.

The controller is further adapted to automatically establish a distance function using the first-control data and the second-control data. Establishing the distance function can include selecting a distance function from a library of functions stored, e.g., in data storage system 1840. Establishing the distance function can also include selecting parameters of the selected distance function. The distance function is preferably established to operate in a desired number of dimensions (e.g., >2), to provide design flexibility, and to operate as a true metric that correlates with distances. Examples of distance functions include, but are not limited to, the following:

Distance functions used in nonparametric tests
χ² (Chi Square)
Kolmogorov-Smirnov (KS) (one-dimensional only; use marginal histograms taken successively to handle multidimensional cases)
Cramer/von Mises (CvM)

Information-theory divergences
Kullback-Liebler (KL) (can be multidimensional)
   Symmetrized KL (take the mean of the KL divergences in both directions)
Jeffrey divergence (JD)

Ground distance measures
Histogram intersection (Overton)
Quadratic form distance (QF)
Wasserstein-Rubinstein-Mallows distance (Earth Movers Distance)
Euclidean distance

In an example, the controller selects a QF distance function. The controller then iteratively adjusts the dissimilarity matrix used by the QF distance function using a metric learning technique. Data from the first and second controls are used, and the parameters of the QF distance function are adjusted to increase the QF distance between a first control and a second control and to reduce the QF distance between two first controls or between two second controls. In this way, a custom metric is produced for each experiment or set of experiments to provide increased accuracy in distance calculations for that experiment.

In another example, the controller iterates over a set of candidate distance functions. The controller computes distances within the first controls or the second controls, and between a first control and a second control. The controller can compute one or more distances in each set for each candidate distance function. The controller then selects one of the candidate distance functions to be the established distance function. In an example, Fisher's criterion is used to select the established distance function. Under an appropriate definition of variance and covariance of distributions with respect to a distance function (rather than with respect to Euclidean distance, e.g., x-mean), the controller selects the metric that has the highest ratio of the variance between the controls to the variance within each control. For example, variance can be defined as

Var(X)=Cov(X,X)=E(d(X,mean),d(X,mean))=E(d(X,mean)²),

where X is one of the tested control distributions, ‘mean’ is the mean control distribution, and d( . . . , . . . ) is the given metric (distance function).

In general, metrics are evaluated by calculating the distances between measurements within control groups, and the distances between measurements in different control groups, and selecting the distance function that most reduces the former and increases the latter. Variance is computed using distances between the mean distribution of the controls and the distribution of a particular control.

The controller is further adapted to receive indication(s) of reference data and test data in the measured dataset (e.g., TIPs or well numbers). The test data includes data from at least two different ones of the second factors. In an example, the second factors are dosages. The test data includes measurements at different dosages so that a dose-response curve can be produced. The controller retrieves the reference data and the test data from the stored measured dataset in the memory.

Using the determined distance function, the controller computes a respective distance between the reference data and the test data for each of the ones of the second factors in the test data. The distance can be two-way, e.g., QF, or one-way, e.g., KL. One-way distances can be computed from the reference data to the test data or vice versa. The reference can be in the first-control data, in the second-control data, or in neither control data.

The controller then fits a curve to the computed respective distances with reference to the ones of the second factors in the test data. For example, when the second factors are dosages, the controller fits a curve to the distance as a function of dosage. Each set of test data at one of the second factors corresponds to a point to which the curve is fit. In various aspects, the controller fits a particular curve model to the data, e.g., linear, polynomial, logarithmic, exponential, log-normal, Gompertz, Weibull, or sigmoidal (e.g., logistic or log logistic). These models can have any number of parameters, e.g., 2, 3, 4, or 5 parameters.

In various aspects, the controller uses maximum-likelihood criteria to pick a best-fit of several possible sigmoidal curve types.

The controller is further adapted to analyze the fitted curve to determine a parameter of interest, e.g., a biological or clinical parameter such as IC50. In an example, the controller finds the X coordinate (second factor value) at which the Y coordinate of the fitted curve is halfway between the minimum and maximum points of the fitted curve in the domain of second factors (or the smallest continuous domain including all of the second factors in the test data), as discussed above (e.g., conventional IC50 with a gated population). In another example, the fitted curve is sigmoidal or another curve having a single inflection point, e.g., a symmetrical function. The controller automatically locates that inflection point (e.g., by numerically or symbolically taking the second derivative of the fitted curve and locating its roots using, e.g., symbolic techniques or Newton-Rhapson iteration) and determines the parameter to be the X coordinate of the inflection point. In another example particularly useful with asymmetrical curves, horizontal asymptotes of the top and bottom of the fit sigmoid are determined. In many cases, these asymptotes will exist, since the distance will be bound to lie between a positive control and a negative control. Distances farther from the negative control than is the positive control (or vice versa) can indicate that different controls should be used. The horizontal line halfway between the asymptotes is determined. The point at which the sigmoid intercepts that line is the IC50 point; its X coordinate is the analog of IC50. In general, in aspects using a metric (as opposed to, e.g., a divergence) as a distance function, half of the biological response can correspond to half of the distance between the controls, for an appropriate selection of the controls.

Other parameters of interest can include inhibitory concentration at different percentage levels between 0 and 100%. For example, IC10 (10%), IC80, or IC90 can be determined analogously to IC50. Half maximal effective concentration (EC50), EC10, EC90, or any other EC between 0 and 100% can also be determined. EC50 is the concentration or dosage at which half the control response is induced (as opposed to inhibited, for IC50). Selectivity index can also be determined as the ratio between effective doses of two different drugs. For example, the selectivity can be the ratio of IC50s from two different dose-response (fitted) curves. Selectivity index is a measure of how much more potent one drug is than another (relative potency)

In various aspects, the first-control data and the second-control data have respective disjoint ranges of values for the corresponding measurement(s) of a selected one or more of the variable(s). For example, the intensity measurements of calcein fluorescence in the first control can be above 20 (arbitrary units) and such measurements in the second control can be below 5 (arbitrary units). A threshold is thus defined at which all the measurements in the first-control data are above (or below) the threshold and all the measurements in the second-control data are below (above) the threshold. For some datasets, numerous candidate thresholds will exist; any can be selected (e.g., any value >=5 and <=20 in the example above). The reference data and the test data, unlike the controls, each include values greater than the threshold and values less than the threshold. The threshold is an example of where a gate could be placed in conventional analysis. However, in these aspects, a gate is not used; data above and below the threshold contribute to the computation of the distance. Since a gate is not used, no yes/no decision is made while determining the distance, and hence the parameter, in these aspects.

In various aspects, each of the first-control data and the second-control data has at least one respective mode for the corresponding measurement(s) of a selected one or more of the variable(s). The mode can be a local maximum or peak of a histogram of the selected variable(s). The reference data or the test data includes values greater than a selected threshold and values less than the selected threshold, wherein the selected threshold is between the respective disjoint modes. This advantageously permits determining distances even in the presence of overlapping controls. If the respective modes of the first and second controls are very close together so that each has significant data (e.g., significant measured intensities) in a single, overlapping range, gating based on a single threshold will mis-classify some of the data from each control. This reduces the accuracy of gated analyses. However, distances can still be computed between those controls, and between measurements and references. In various aspects with such overlap, metric learning is used as described herein to select a distance metric that can effectively differentiate first controls from second controls.

In various aspects, processor 1586 is further adapted to receive a target range, e.g., via interface 1530. For example, the target range can be [1, 50]. The target range can be open, semi-open, or closed, and can include multiple disjoint or adjacent subranges. The range can include ∞ or −∞ as one or both endpoints. The processor automatically produces an indication of each first factor for which the computed parameter is within the target range. In the example of FIG. 12, given in Table 1, above, conditions 01, 02, 04, 09, and 10 have gate-free IC50 values in the example range [1, 50].

Processor 1586 can execute instructions stored on a non-transitory tangible computer-readable medium in order to process the dataset. The instructions can include instructions to automatically establish a distance function using the first-control measurements and the second-control measurements; instructions to await receipt of a first modifying-factor selection of one of the plurality of modifying factors (e.g., which drug should be tested); instructions to select a plurality of sets of the test measurements so that the measurements in each set correspond to the first modifying-factor selection and to a respective, different one of the series factors; instructions to compute respective distances, using the established distance function, between the respective sets (or subsets) of the test measurements and at least some of the reference measurements; instructions to fit a curve to the computed respective distances as a function of the respective ones of the series factors; and instructions to determine the parameter from the fitted curve.

FIG. 15 is a flowchart of ways of determining a parameter of a test system from flow cytometry data according to various aspects. Processing begins with step 1605.

In step 1605, a measured dataset of the flow cytometry data is received. The measured dataset containing measurements of a variable, each measurement corresponding to one of a plurality of modifying factors (e.g., which drug) and to one of a plurality of series factors (e.g., which concentration of the drug). The measurements include first-control measurements, second-control measurements, reference measurements, and test measurements. The reference measurements can also be first-control measurements or second-control measurements. Step 1605 is followed by step 1610.

In step 1610, using a controller, a distance function is automatically established using the first-control measurements and the second-control measurements. Various ways of doing this, e.g., tuning the dissimilarity matrix of a QF distance function, are described herein. Step 1610 is followed by step 1615.

Referring back to FIG. 6C, for this distance computation, an adjusted quadratic form (QF) distance metric was used. This and various other metrics fulfill the triangle inequality requirement, so determining the distances between a reference and test A and between the reference and test B permit determining the distance between tests A and B. QF and other distance metrics can be adjusted to perform well for a known set of controls. The well-known techniques of metric learning can be advantageously used in the new context of distance estimation of flow cytometric data.

Distance metric learning is a technique developed within the field of statistical machine learning and addresses the problem of designing proper distance functions. Suppose an experimentalists indicates that certain results in an input space of a biological experiment (e.g., measurements of a first control) are considered to be similar under some criteria (e.g., calcein fluorescence), and certain other results (e.g., measurements of a second control different from the first control) are known to be very dissimilar under those criteria. The process of distance metric learning permits a processor to automatically provide a distance metric that respects these relationships, i.e., one that assigns small distances between the similar pairs, and large distance between dissimilar pairs.

In various examples, measurements of control samples are used to determine the metric, as is discussed herein. In an example, a plate with live cells in half the wells and dead cells in half the wells can be run, and the resulting data can be used to adjust the distance function by metric learning. One controls plate can be run per experimental cycle, per day, or as often as needed depending on the variability of the flow cytometer. Controls can also be included as tubes on a plate. Individual control tubes can also be measured periodically. The distance metric provided using those controls can be useful for computing distances between test measurements and control measurements, or for computing distances between different test measurements. In an example, the toxicity of a drug is measured (live-cell and dead-cell controls). The reference is acetylsalicylic acid. This permits readily determining the toxicity of a new drug with respect to the toxicity of acetylsalicylic acid.

In step 1615, a first modifying-factor selection of one of the plurality of modifying factors is received. This selection can indicate, e.g., which drug an operator desires to test. The selection can also be received from an automated program or system that directs the processor to test various drugs, e.g., drugs listed in a drug box such as that shown in FIG. 7B. Step 1615 is followed by step 1620.

In step 1620, using the controller, distances are automatically computed using the established distance function. Respective distances are computed, between respective sets (or subsets) of the test measurements and at least some of the reference measurements. Specifically, the measurements in each set of the test measurements correspond to the first modifying-factor selection. Each set of the test measurements, and the measurements therein, corresponds to a respective, different one of the series factors. Therefore, the respective distances are distances, e.g., for multiple doses (series factors) of a given drug (modifying factor) with respect to a reference (a positive or negative control, or a drug with a known effect on the cell population under test). In various aspects, the distance function is a quadratic form (QF) distance. Step 1620 includes computing QF distances between the respective sets of the test measurements and the at least some of the reference measurements. Step 1620 is followed by step 1625.

In step 1625, using the controller, a curve is automatically fitted to the computed respective distances as a function of the respective ones of the series factors. This fitting can be performed using least-squares regression or other mathematical fitting or error-minimization techniques. Examples of data and fitted curves are shown in FIGS. 6B and 6C. Step 1625 is followed by step 1630.

The series factors, and the fitted curves, are not required to be drug concentrations. Other ordinal, interval, or ratio scales can be used. For example, the series factors can be age of a patient from whom the test cells were drawn, or can be time (e.g., number of days) between a vaccination and when the test cells were drawn.

In various aspects, mathematical techniques are used to fit curves. Example of techniques used for regression in the field of Generalized Linear Models include IWLS (Iterative weighted, or reweighted, least squares), Nelder-Mead, BFGS optimization (Broyden-Fletcher-Goldfarb-Shannon), CG (conjugate gradient), or L-BFGS-B (limited-memory BFGS). For many choices of regression, inflection points or asymptotes can be determined analytically so that they do not need to be determined numerically. Some models have model parameters that directly indicate the inflection points or asymptotes; other models have fitting parameters from which inflection-point locations or asymptotes can be calculated. IC50 and EC50 points, and other parameters, can be also found numerically if a model for response curve uses non-parametric regression techniques such as splines.

In step 1630, using the controller, the parameter is automatically determined from the fitted curve. The parameter can be IC50 or another parameter described herein.

In various aspects, curve-fitting step 1625 includes fitting a sigmoid curve to the data. Determining-parameter step 1630 then includes automatically locating the series factor corresponding to the inflection point of the fitted curve and selecting that series factor as the parameter. Series factors can be continuous, so even if the inflection point does not fall exactly on a measured point of one of the series factors, the parameter can still be determined.

In various aspects, establishing step 1610 includes using metric learning to determine parameters of the QF distance function so that the distance according to the distance function between any two of the first-control measurements or between any two of the second-control measurements is less than the distance between any one of the first-control measurements and any one of the second-control measurements.

In various aspects, computing-distances step 1620 includes automatically determining a first density map of the measurements in at least one of the sets of test measurements. A second density map of the at least some of the reference measurements is also determined. A distance between the first density map and the second density map is automatically computed using the established distance function.

In an example, density estimation is performed, e.g., kernel density estimation, on an n-dimensional (n-d) histogram to produce an n-d matrix characterizing density estimation. The n-d histogram can also be used as-is. The value of n is at least 1. In an example, the distance is computed between 1M points of test data and 1M points of reference data. This is done by comparing the densities of the test data points in the one-or-more-dimensional space defined by the variables measured (e.g., a 4-D space if FS, SS, mBBr, and calcein were measured). In various examples, the density matrices are normalized to remove effects from varying numbers of cells.

In various aspects, each biological cell is a point in an n-d space in which each coordinate is the response of that cell to the measurement type for that coordinate. The n-d space is divided into bins. The bins can be equal-sized or not, depending on the metric; probabilistic binning can be used to provide equal numbers of measurements in each bin and different bin sizes. Each metric has its own procedure for binning. The number or percentage of cells in each bin is that bin's density. The density values go into an n-d matrix and the distances are calculated between two of those n-d matrices.

In various aspects, earth-mover's distance is used. Earth-mover's distance computes distance between two probability distributions over a region. Informally, if the distributions are interpreted as piles of dirt a specific region, the metric provides the minimum cost of reshaping on pile into the other; where the cost is defined as the amount of dirt moved times the distance by which it is moved.

Whichever distance function is established, the distance computed is from a whole subpopulation of cells to another whole subpopulation. No yes/no decision or other feature of a specific subpopulation (in isolation from other subpopulations) is computed.

In various aspects, data are advantageously considered in distance calculations that would not have been considered in gated calculations. Specifically, the first-control measurements of a selected one (or more than one) of the variable(s) and the second-control measurements of the selected one of the variable(s) include respective disjoint ranges of values. In the example shown in FIG. 6A, one of the controls has data in the range (approximately) [8, 20], and the other control has data in the range (approximately) [38, 52]. A threshold can then be selected between those disjoint ranges. In this example, the threshold can be anywhere on the range of approximately (20, 38). Either the reference data or the test data, or both, includes values of the selected one of the variable(s) greater than the threshold and values less than the threshold. In this way, the whole cell population under test (e.g., all cells that contributed to the histogram of FIG. 6A) is considered when determining how similar the test is to the reference, not just those on one side of a threshold. These aspects can also be used for multidimensional data in which the density map is an m×n (m, n>1) matrix rather than a vector (m×1 or 1×n).

In other aspects, each of the first-control measurements of a selected one (or more than one) of the variable(s) and the second-control measurements of the selected one of the variable(s) includes one or more respective modes, e.g., local maxima or peaks. In the example of FIG. 6A, the modes of the histogram are at approximately 13 and 46 (the local maxima of the histogram). One of these peaks, in this simulated example, corresponds to a contribution from the first control; the other peak corresponds to a contribution from the second control. A threshold is selected between two different modes of the respective modes, e.g., on approximately (13, 46). Either the reference data or the test data, or both, includes values of the selected one of the variable(s) greater than the selected threshold and values less than the threshold. Even when distributions are multimodal, distances can be calculated for test data or reference data that overlap a threshold between any two modes. This permits analyzing heavily-overlapping, multimodal controls that would be infeasible to analyze by gating. In various of these aspects, metric learning is used in establishing the distance function for controls having modes as described above.

In various aspects, the determining-parameter step 1630 includes automatically locating an inflection point of the fitted curve and selecting the parameter as the abscissa value of the located inflection point. In various aspects, step 1630 includes automatically determining two horizontal asymptotes of the fitted curve and selecting the parameter as the abscissa value at which the fitted curve has an ordinate value substantially halfway between the ordinate values of the determined horizontal asymptotes.

In various aspects, the method further includes steps 1640 and 1645. Step 1630 is followed by step 1640 or step 1645. Step 1640 can be executed any time before step 1645.

In step 1640, a target range is received. This can be, e.g., [1, 50], as described above with reference to FIG. 15. Step 1640 is followed by step 1645. In step 1645, using the controller, an indication of each first factor for which the computed parameter is within the target range is produced. This is also as discussed above.

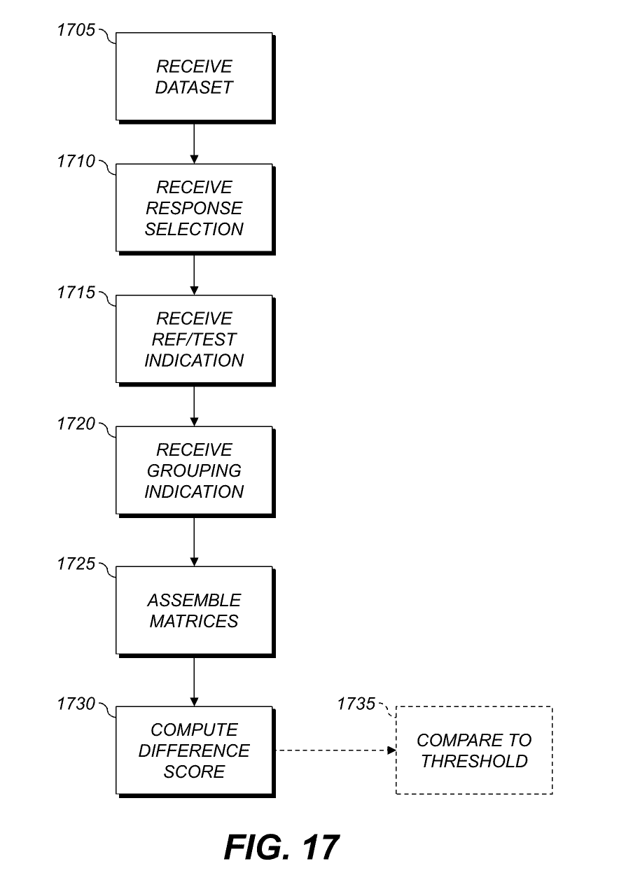

FIG. 17 is a flowchart of ways of determining differences in one or more biological response(s) by cell(s) to factor(s) according to various aspects. Processing begins with step 1705.

In step 1705, a measured dataset is received. The measured dataset is organized according to at least a first factor and a second factor, each factor including a respective set of values. The factors can be, e.g., drugs, dosages (slide 45), or activation molecules. Any number of factors can be used. The measured dataset includes measurement(s) of one or more of the biological response(s) to one or more substance(s). The response(s) can be responses of a cell or one of various cells in a well to a substance in that well, e.g., a drug. Each measurement corresponds to one of a plurality of values of the first factor and to one of a plurality of values of the second factor. For example, each well can include a specific drug (first-factor value) at a specific concentration (second-factor value). The measured data can be a full-factorial combination of values of factors or not. Each substance corresponds to the respective first-factor value and the respective second-factor value. For example, the substance can be a particular drug at a particular concentration, or a particular aggregate of a drug (first-factor value) and an activation molecule (second-factor value). Step 1705 is followed by step 1710.

The measured data can be results of a biological experiment, or in silico simulated data. The measured data can include positive and negative controls that represent the extreme conditions of the biological population under the variables measured (e.g., live vs. dead cells, for a toxicity test).

In step 1710, a selection of one or more of the measured biological response(s) is received. In an example, FS, SS, and calcein are measured for each well. The selection can be “calcein.” In this disclosure, dyes or stains that indicate a particular biological response are treated uniformly with the responses themselves. Step 1710 is followed by step 1715.

In step 1715, an indication is received that one or more of the measurement(s) in the measured dataset are reference measurement(s), and one or more of the measurement(s) in the measured dataset that are not reference measurement(s) are test measurement(s). For example, some wells can be controls or references and others can be tests. It is permissible but not necessary that the dataset contain only data from a given plate of wells. Step 1715 is followed by step 1720.

In step 1720, an indication is received of a grouping to compare. In an example, data from a well with a drug is to be compared to data from a well without a drug. The indication of the grouping includes, in this example, the well numbers (or other identifiers in the dataset) of which reference and which test to compare. Step 1720 is followed by step 1725.

In step 1725, using a controller, a reference matrix is automatically assembled by selecting from the reference measurement(s) according to the received grouping indication. A test matrix is automatically assembled by selecting from the test measurement(s) according to the received grouping indication. The test and reference matrices can be any number of dimensions and can have any extent >=1 in any of those dimensions. In an example, the reference matrix and the test matrix are three-dimensional matrices. Step 1725 is followed by step 1730.

In step 1730, using the controller, a difference score is automatically computed. The distance score is computed between the control matrix and the test matrix.

In various aspects, step 1730 is followed by step 1735. In step 1735, the computed difference score is automatically compared to a selected threshold using the controller. If the difference score exceeds the threshold, a report is produced. The report can include the received grouping indication and be provided to a display, printer, or other output device, or to a computing device, e.g., connected to the controller via a network.

In view of the foregoing, various aspects provide automated analysis and determination of biological parameters from flow cytometry data. A technical effect of various aspects is to provide an objective, repeatable measure of the effects of factors on cells.

Throughout this description, some aspects are described in terms that would ordinarily be implemented as software programs. Those skilled in the art will readily recognize that the equivalent of such software can also be constructed in hardware (hard-wired or programmable), firmware, or micro-code. Accordingly, aspects of the present invention may take the form of an entirely hardware embodiment, an entirely software embodiment (including firmware, resident software, or micro-code), or an embodiment combining software and hardware aspects. Software, hardware, and combinations can all generally be referred to herein as a “service,” “circuit,” “circuitry,” “module,” or “system.” Various aspects can be embodied as systems, methods, or computer program products. Because data manipulation algorithms and systems are well known, the present description is directed in particular to algorithms and systems forming part of, or cooperating more directly with, systems and methods described herein. Other aspects of such algorithms and systems, and hardware or software for producing and otherwise processing signals or data involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

FIG. 18 is a high-level diagram showing the components of an exemplary data-processing system for analyzing data and performing other analyses described herein. The system includes a data processing system 1810, a peripheral system 1820, a user interface system 1830, and a data storage system 1840. The peripheral system 1820, the user interface system 1830 and the data storage system 1840 are communicatively connected to the data processing system 1810. Data processing system 1810 can be communicatively connected to network 1850, e.g., the Internet or an X.25 network, as discussed below. Processor 1586 (FIG. 1515) can include one or more of systems 1810, 1820, 1830, 1840, and can connect to one or more network(s) 1850.

The data processing system 1810 includes one or more data processor(s) that implement processes of various aspects described herein. A “data processor” is a device for automatically operating on data and can include a central processing unit (CPU), a desktop computer, a laptop computer, a mainframe computer, a personal digital assistant, a digital camera, a cellular phone, a smartphone, or any other device for processing data, managing data, or handling data, whether implemented with electrical, magnetic, optical, biological components, or otherwise.

The phrase “communicatively connected” includes any type of connection, wired or wireless, between devices, data processors, or programs in which data can be communicated. Subsystems such as peripheral system 1820, user interface system 1830, and data storage system 1840 are shown separately from the data processing system 1810 but can be stored completely or partially within the data processing system 1810.

The data storage system 1840 includes or is communicatively connected with one or more tangible non-transitory computer-readable storage medium(s) configured to store information, including the information needed to execute processes according to various aspects. A “tangible non-transitory computer-readable storage medium” as used herein refers to any non-transitory device or article of manufacture that participates in storing instructions which may be provided to processor 304 for execution. Such a non-transitory medium can be non-volatile or volatile. Examples of non-volatile media include floppy disks, flexible disks, or other portable computer diskettes, hard disks, magnetic tape or other magnetic media, Compact Discs and compact-disc read-only memory (CD-ROM), DVDs, BLU-RAY disks, HD-DVD disks, other optical storage media, Flash memories, read-only memories (ROM), and erasable programmable read-only memories (EPROM or EEPROM). Examples of volatile media include dynamic memory, such as registers and random access memories (RAM). Storage media can store data electronically, magnetically, optically, chemically, mechanically, or otherwise, and can include electronic, magnetic, optical, electromagnetic, infrared, or semiconductor components.

Aspects of the present invention can take the form of a computer program product embodied in one or more tangible non-transitory computer readable medium(s) having computer readable program code embodied thereon. Such medium(s) can be manufactured as is conventional for such articles, e.g., by pressing a CD-ROM. The program embodied in the medium(s) includes computer program instructions that can direct data processing system 1810 to perform a particular series of operational steps when loaded, thereby implementing functions or acts specified herein.

In an example, data storage system 1840 includes code memory 1841, e.g., a random-access memory, and disk 1842, e.g., a tangible computer-readable rotational storage device such as a hard drive. Computer program instructions are read into code memory 1841 from disk 1842, or a wireless, wired, optical fiber, or other connection. Data processing system 1810 then executes one or more sequences of the computer program instructions loaded into code memory 1841, as a result performing process steps described herein. In this way, data processing system 1810 carries out a computer implemented process. For example, blocks of the flowchart illustrations or block diagrams herein, and combinations of those, can be implemented by computer program instructions. Code memory 1841 can also store data, or not: data processing system 1810 can include Harvard-architecture components, modified-Harvard-architecture components, or Von-Neumann-architecture components.

Computer program code can be written in any combination of one or more programming languages, e.g., Java, Smalltalk, C++, C, or an appropriate assembly language. Program code to carry out methods described herein can execute entirely on a single data processing system 1810 or on multiple communicatively-connected data processing systems 1810. For example, code can execute wholly or partly on a user's computer and wholly or partly on a remote computer or server. The server can be connected to the user's computer through network 1850.

The peripheral system 1820 can include one or more devices configured to provide digital content records to the data processing system 1810. For example, the peripheral system 1820 can include digital still cameras, digital video cameras, cellular phones, or other data processors. The data processing system 1810, upon receipt of digital content records from a device in the peripheral system 1820, can store such digital content records in the data storage system 1840.

The user interface system 1830 can include a mouse, a keyboard, another computer (connected, e.g., via a network or a null-modem cable), or any device or combination of devices from which data is input to the data processing system 1810. In this regard, although the peripheral system 1820 is shown separately from the user interface system 1830, the peripheral system 1820 can be included as part of the user interface system 1830.

The user interface system 1830 also can include a display device, a processor-accessible memory, or any device or combination of devices to which data is output by the data processing system 1810. In this regard, if the user interface system 1830 includes a processor-accessible memory, such memory can be part of the data storage system 1840 even though the user interface system 1830 and the data storage system 1840 are shown separately in FIG. 18.

In various aspects, data processing system 1810 includes communication interface 1815 that is coupled via network link 1816 to network 1850. For example, communication interface 1815 can be an integrated services digital network (ISDN) card or a modem to provide a data communication connection to a corresponding type of telephone line. As another example, communication interface 1815 can be a network card to provide a data communication connection to a compatible local-area network (LAN), e.g., an Ethernet LAN, or wide-area network (WAN). Wireless links, e.g., WiFi or GSM, can also be used. Communication interface 1815 sends and receives electrical, electromagnetic or optical signals that carry digital data streams representing various types of information across network link 1816 to network 1850. Network link 1816 can be connected to network 1850 via a switch, gateway, hub, router, or other networking device.

Network link 1816 can provide data communication through one or more networks to other data devices. For example, network link 1816 can provide a connection through a local network to a host computer or to data equipment operated by an Internet Service Provider (ISP).

Data processing system 1810 can send messages and receive data, including program code, through network 1850, network link 1816 and communication interface 1815. For example, a server can store requested code for an application program (e.g., a JAVA applet) on a tangible non-volatile computer-readable storage medium to which it is connected. The server can retrieve the code from the medium and transmit it through the Internet, thence a local ISP, thence a local network, thence communication interface 1815. The received code can be executed by data processing system 1810 as it is received, or stored in data storage system 1840 for later execution.

Following is additional discussion of various aspects.

It's 11:59—you only have a minute to complete or redo the analysis of a 384 well plate and you need the IC50 curves for the boss . . . what do you do?

The first question: Isn't HT screening all about image systems? The answer is yes—probably 99% of HT screening for cellular systems is done by image/detector based screening instruments. This begs another question: what is the reason for this and could that change?

Current perceptions: (1) high throughout/high content screening is really an image based technology. (2) Flow cytometry is nice, but slow and cumbersome.

Why imaging systems?
Many assays use attached cells
Why? Because you need attached cells to do most imaging screens!
It was an easier jump from 96 well plate based assays to 96 well plate based screens.
Imaging systems thus set the standards for HT screens.

“High throughput/high content screening is really an image based technology”. Yes, it is a good technology, but analysis of the data can be cumbersome and very expensive using vast resources from IT groups who spend significant effort to accommodate data. You can collect a limited number of raw variables, and the extension of these minimal data to dozens of derived parameters is sometimes tenuous.

What is needed for single cell high content screening using flow cytometry?
Cells that can be used in suspension assays
To screen a large numbers of drugs, cells, etc you need to be able to collect a huge number of measurements
Very large numbers of samples means a very long time, or a system that must run very fast
The faster you go, the more costly is any mistake
A fast automated system that manages data processing and result delivery effectively & accurately
A collection system without an analysis system does not work

“Flow cytometry is nice, but slow and cumbersome”
Yes it has traditionally been slow
Yes it has traditionally been difficult to analyze large data sets quickly
Yes it has traditionally been sophisticated but cumbersome BUT
Flow cytometry can collect MANY variables on many cells
It is without doubt a superior technology for single cell evaluation for systems biology
If you could run fast and automated, it offers advantages
You can use cheaper plates, and the flatness of the plate surface is a big deal (as it is with imaging systems)

Perhaps the most difficult issue in high throughput flow cytometry is: How do you analyze all those data?

Objectives of this example and related figures:
Remind ourselves of how single cell measurements are done
Define current state of cytometry, how it works & where we are now
Establish criteria for determination of a quality reportable result
Show how future systems may be cost effective and more efficient
The end result is an opportunity for systems approaches to discovery using flow cytometry toolsets
Flow cytometry can be as fast as imaging, but provide significantly more systems information

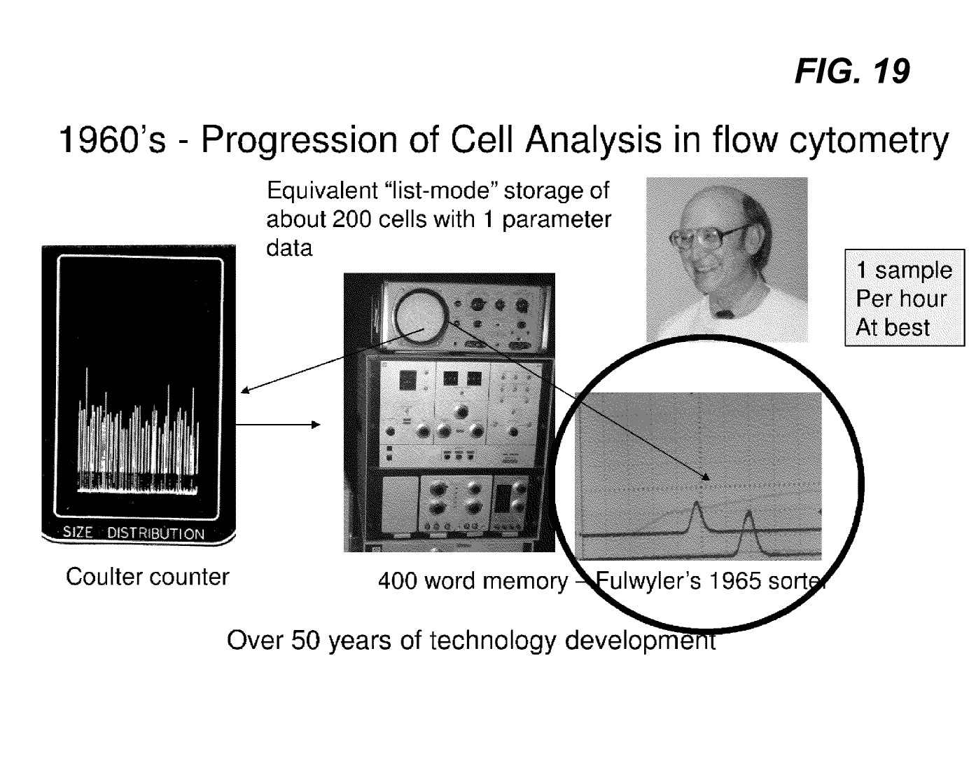

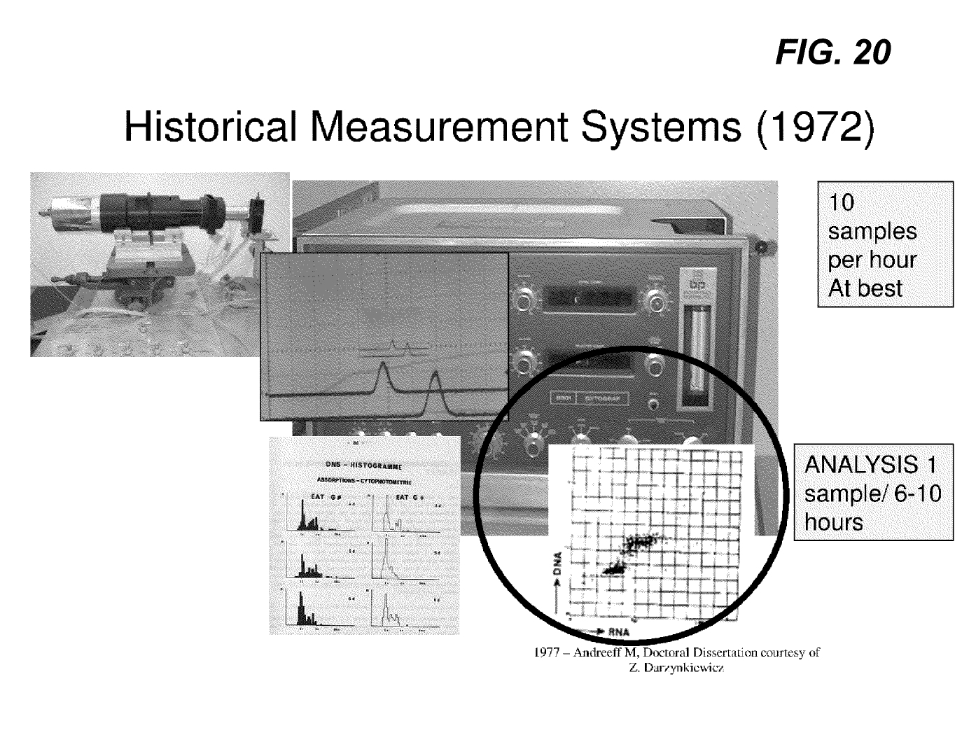

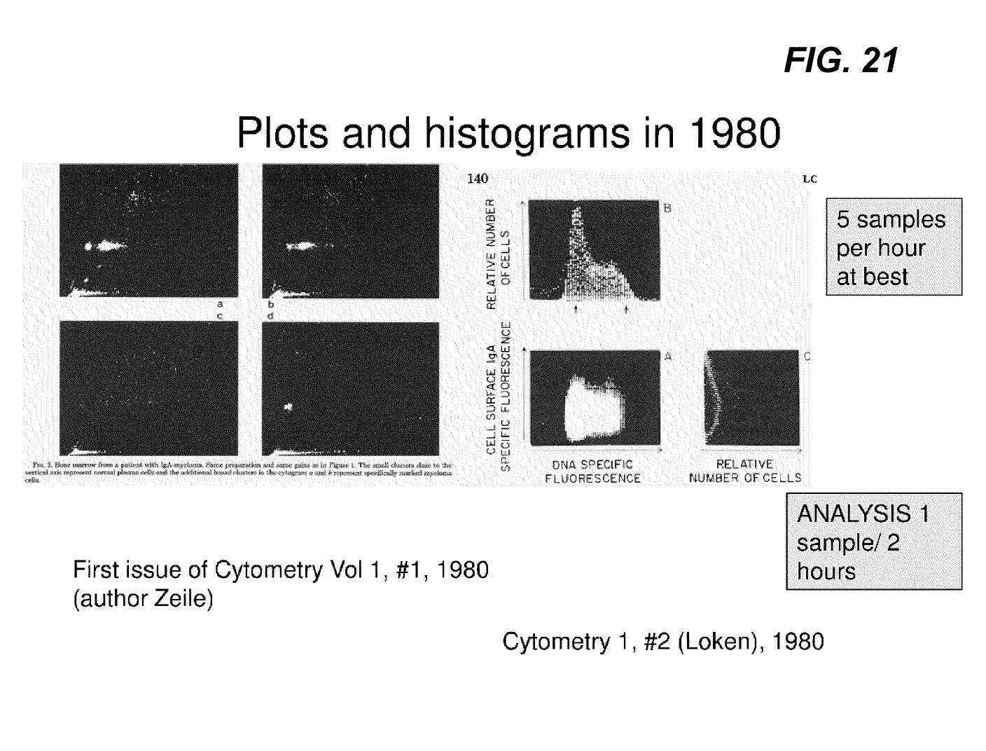

FIGS. 19-21 show historical examples of flow-cytometric analysis. Flow cytometry in 1990 had the following characteristics:
Primarily 1 & 2 color—some 3 color
Single samples, no automation
Networking just became available (thickwire)
Biggest available hard drive 80 megs

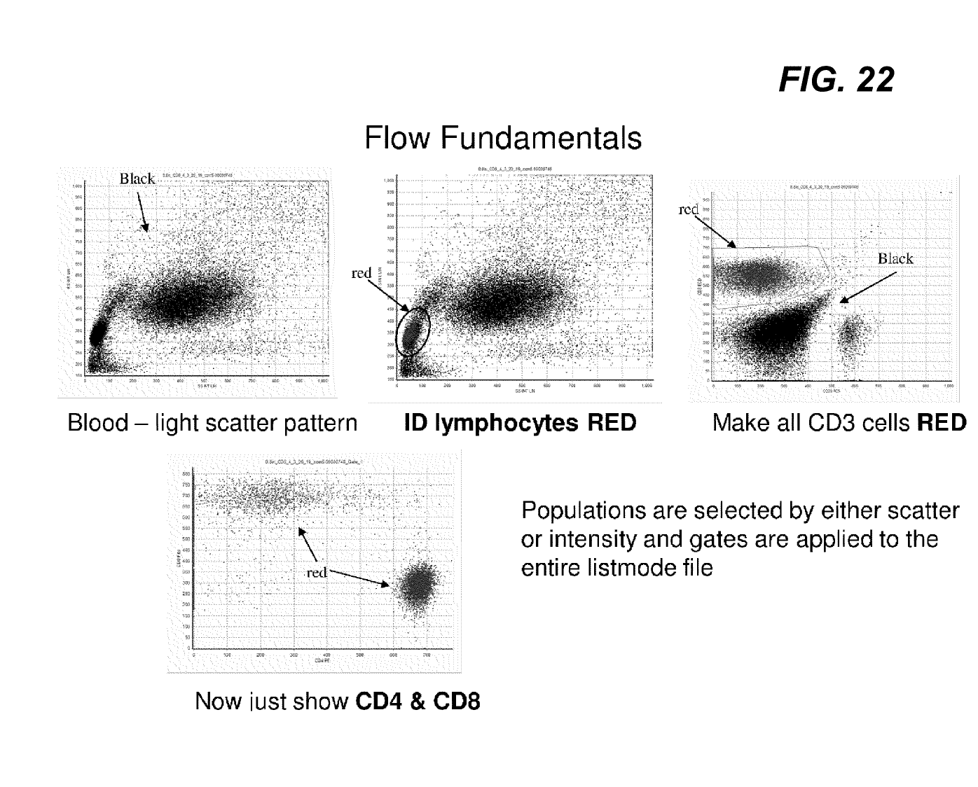

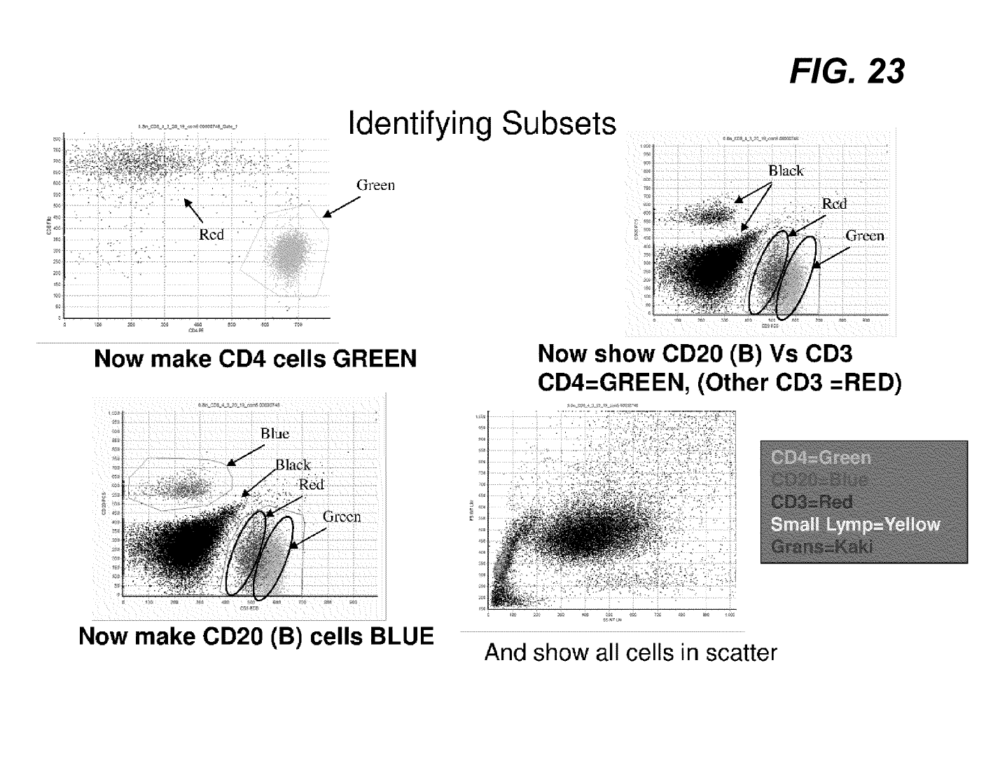

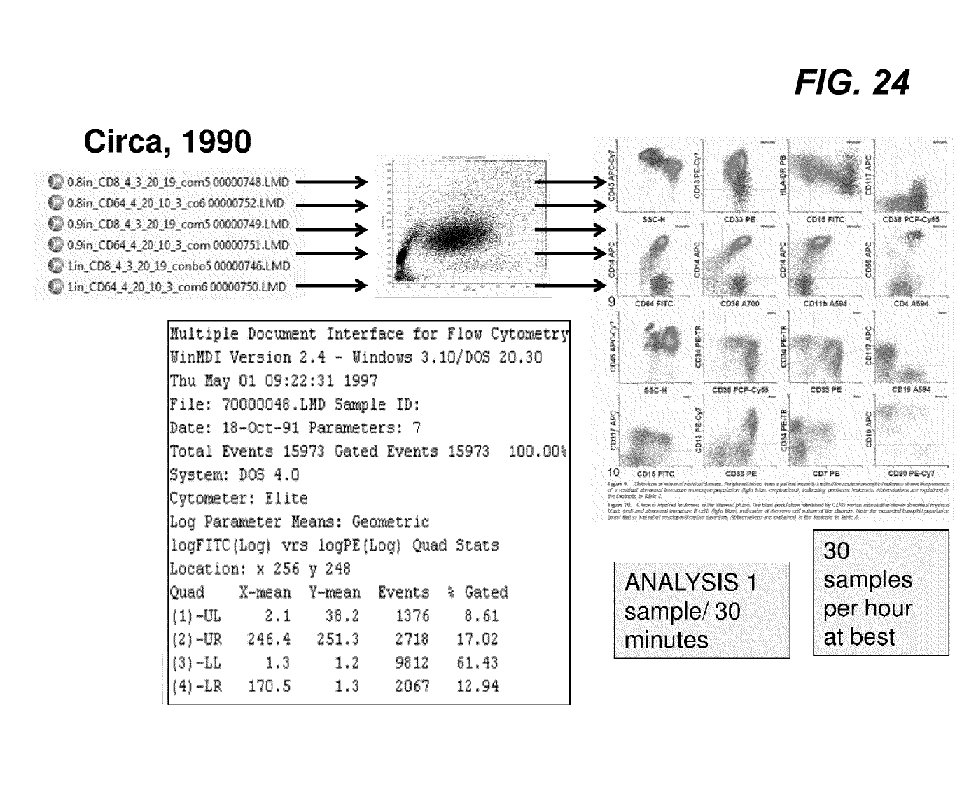

FIGS. 22-24 show examples of gated workflows in flow cytometry.

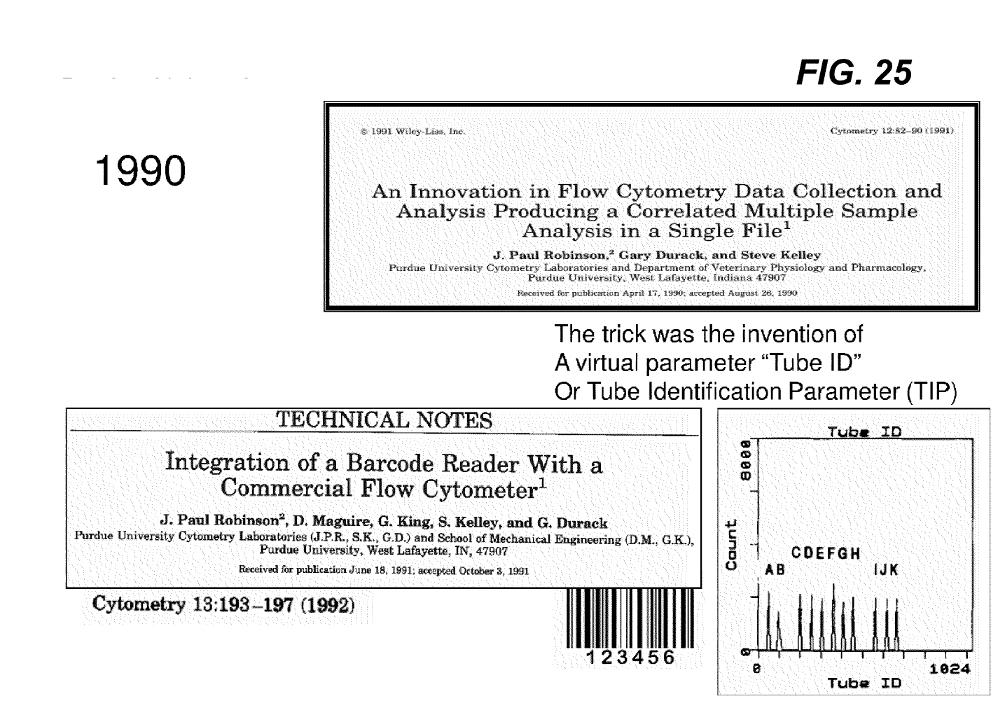

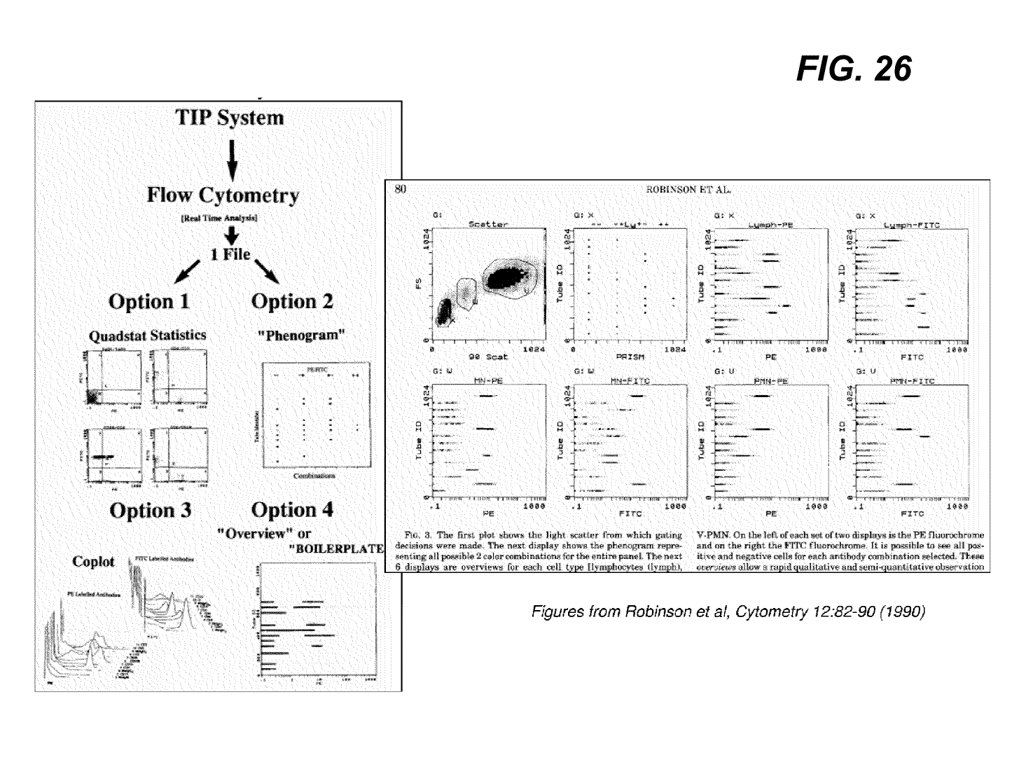

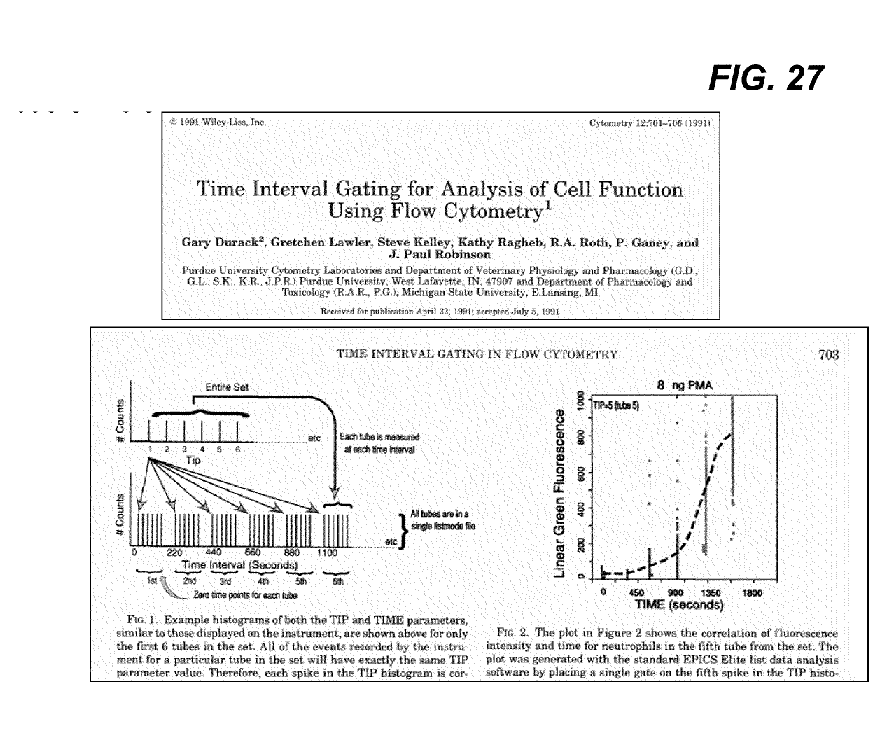

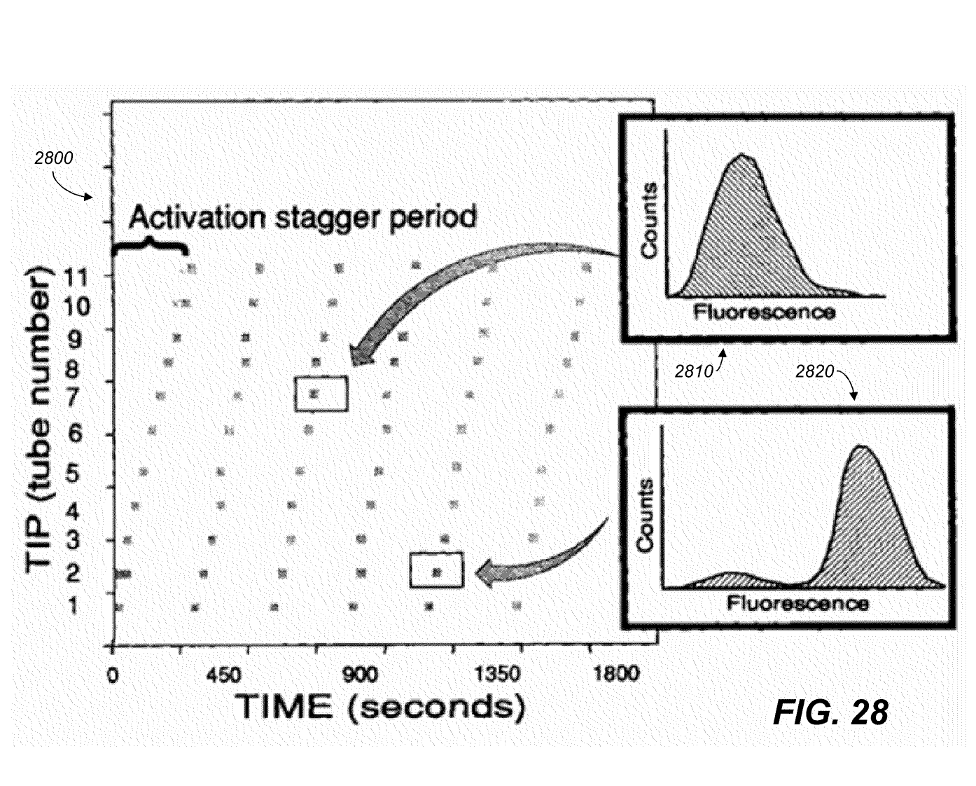

FIGS. 25-28 show historical improvements in cytometric-data tracking and handling.

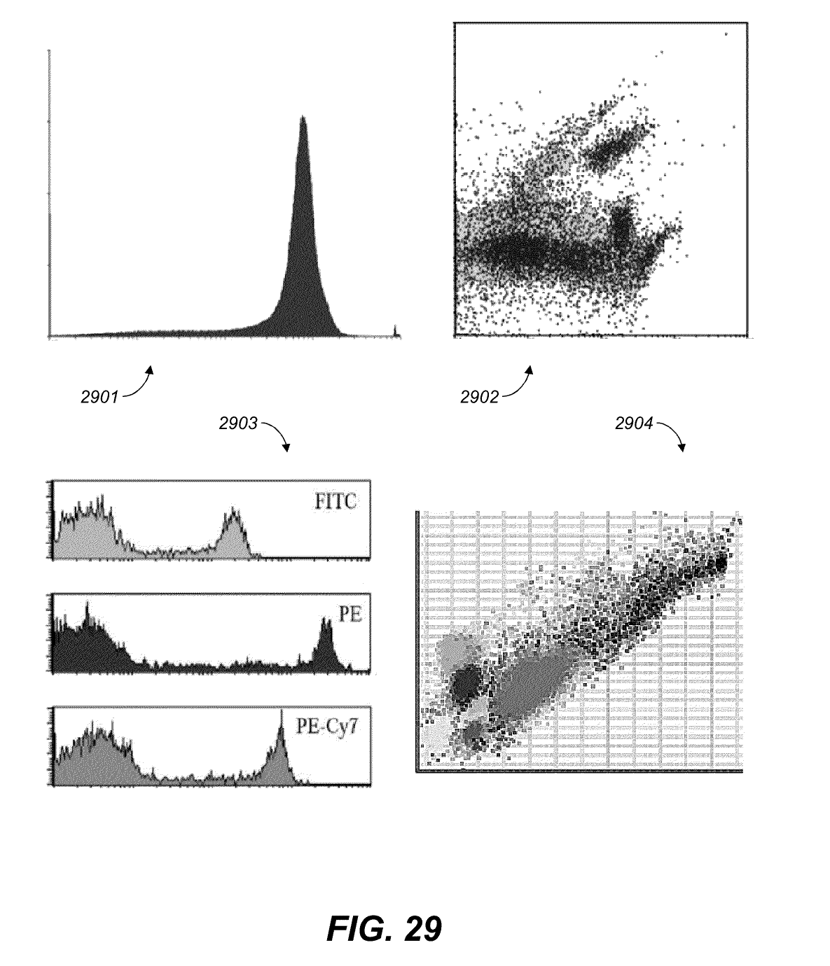

FIG. 29 shows examples of histograms and scatterplots produced by prior flow-cytometric systems.

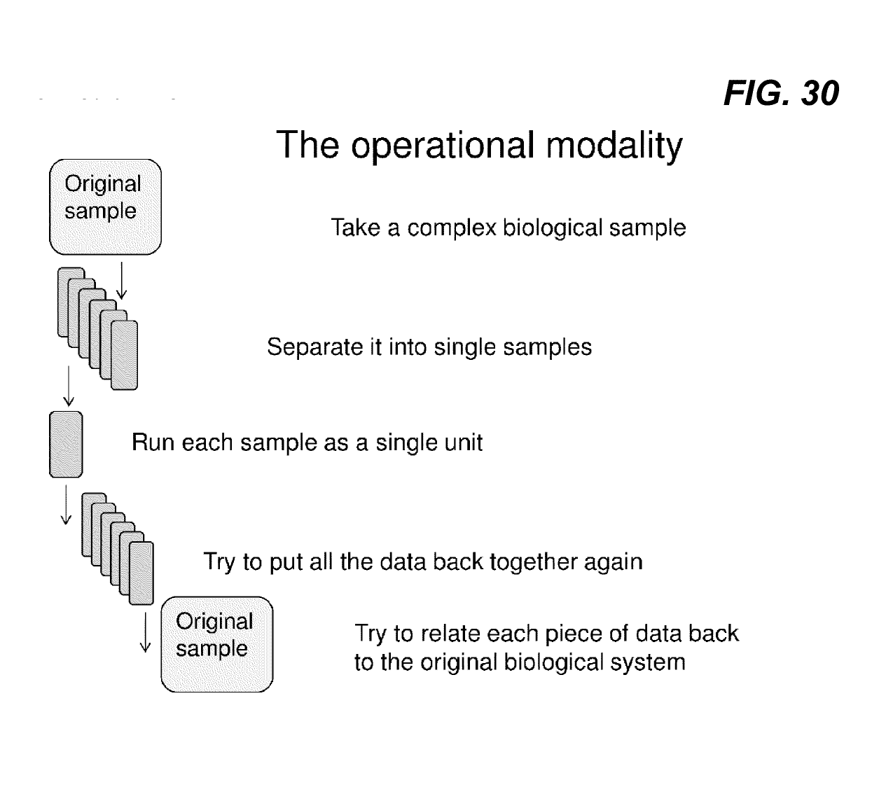

FIG. 30 shows an operational modality of flow-cytometric data analysis. No known prior-art software programs operate in multidimensional space in flow cytometry and analyze samples as sets of linked data.

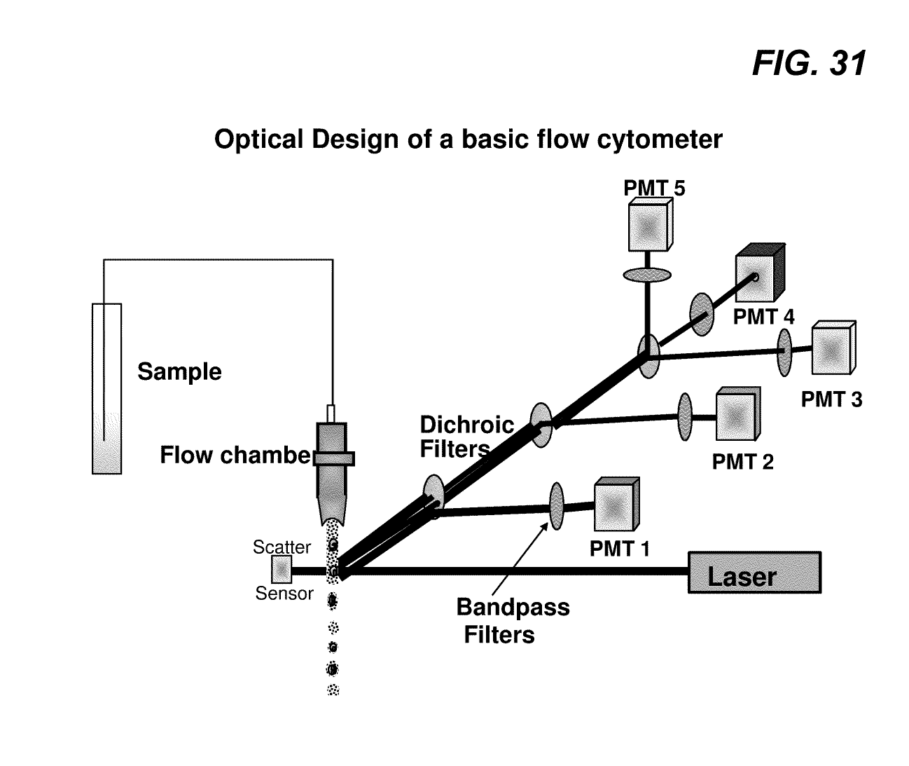

FIG. 31 shows a partly-schematic perspective the optical design of a basic flow cytometer similar to that shown in FIG. 1.

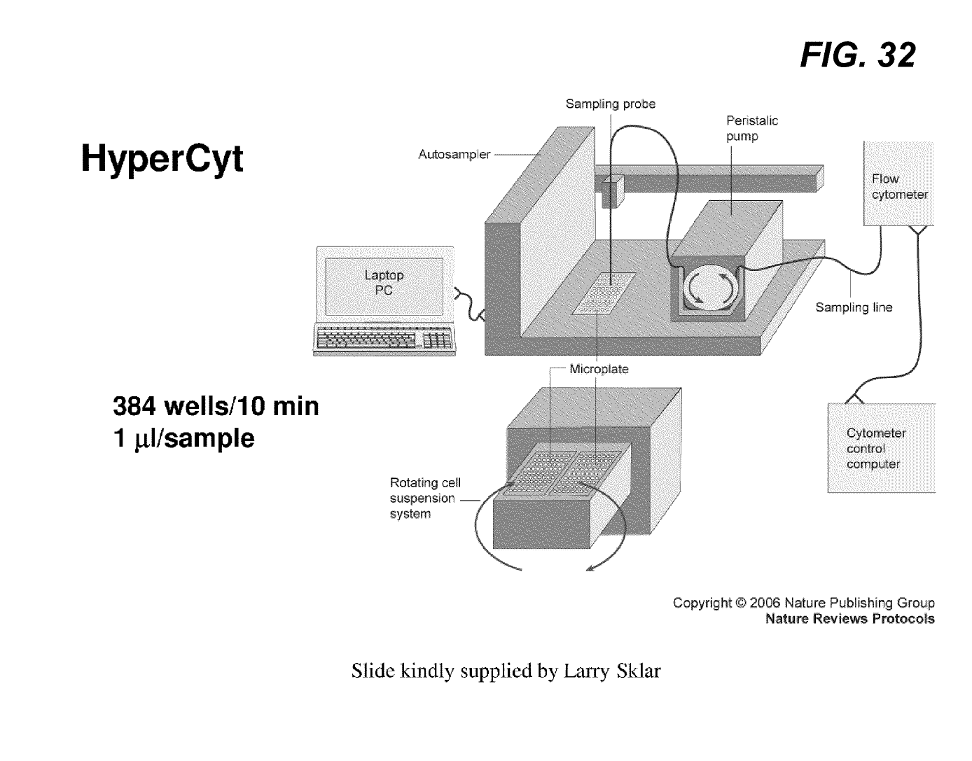

FIG. 32 shows an automated sampling system similar to that shown in FIG. 2.

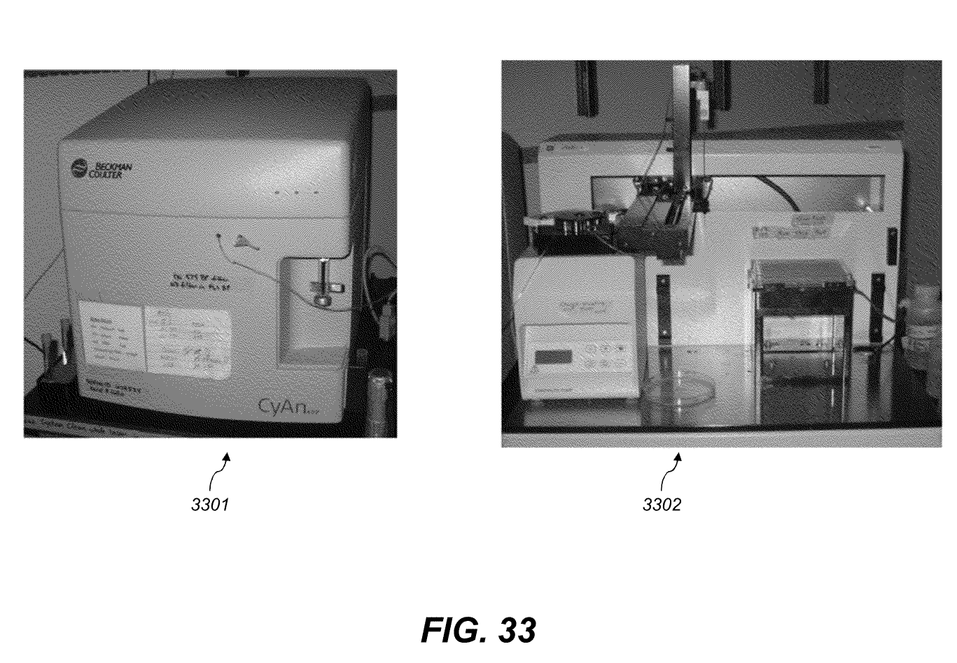

FIG. 33 shows representations of images of a flow cytometer and a HyperCyt™ robot;

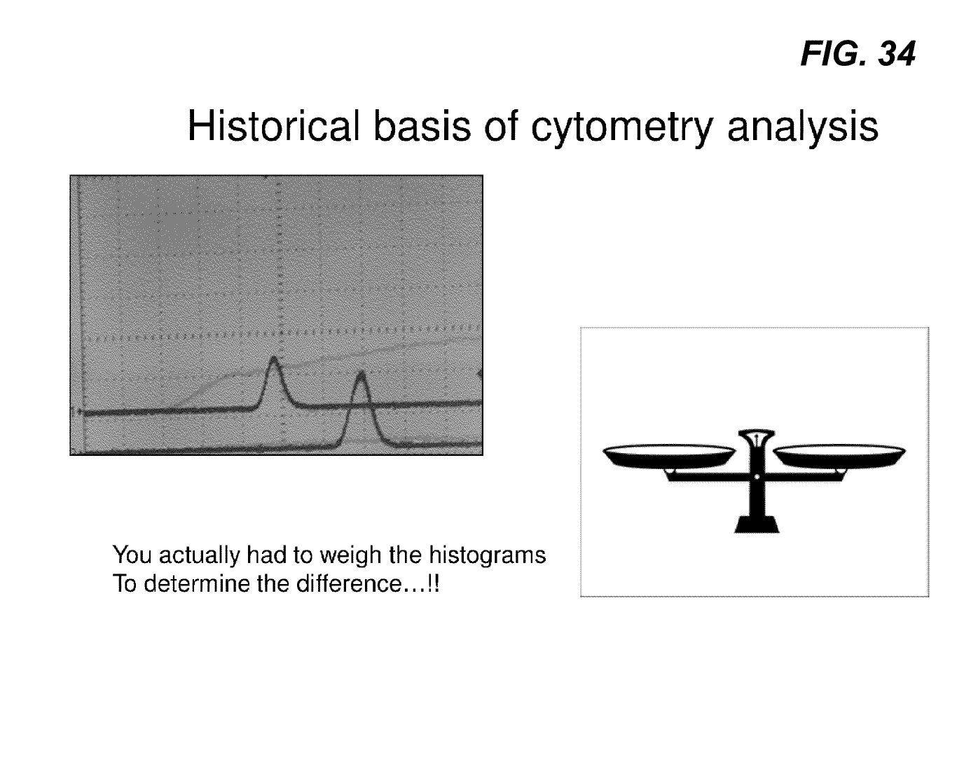

FIG. 34 shows exemplary scatterplots of cytometric data;

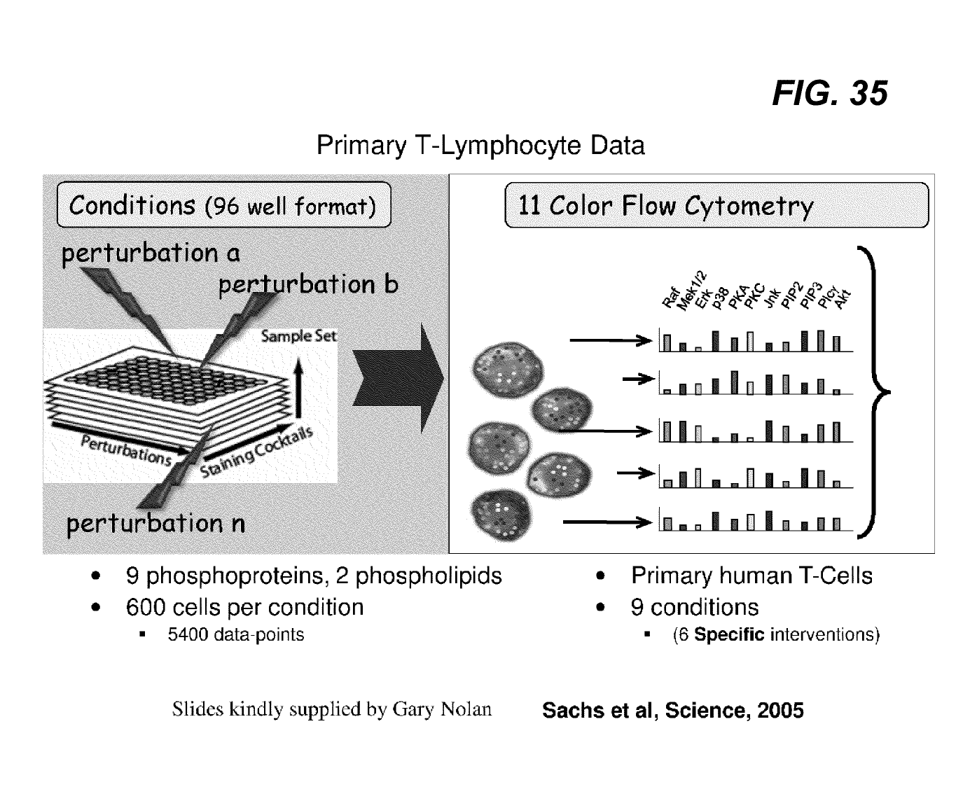

FIG. 35 shows a representation of an experimental plate layout and results;

What is the current message? The new cytometry paradigm is about evaluating systems, not cells! “The media is the message” (Marshall McLuhan, 1970). “The message is in the analysis.”

Example assay: Drug Screen using HL60 cell line
Assay design and setup
Analytical tools—Demonstration
Results generation—Demonstration

PlateAnalyzer

1. Totally integrated software package

2. Easily installable (Installation of a single EXE file)

3. Windows XP, Vista or 7

4. Low diskspace required for all software (4 megs)

5. Software opens and runs very fast (<1 second)

6. Can currently handle up to 384 well plates

7. Can recalculate entire plate when gate change (2 seconds)

8. Visualization of any parameter, or any graph or any gating combination

9. Operates on regular FCS files (or time gated files)

10. Outputs data into CSV (or other output format)

11. Built in parameter creator (i.e., create new derived parameters from current)

12. Perform advanced combinatorial and statistical operations

13. Just show me the curves!

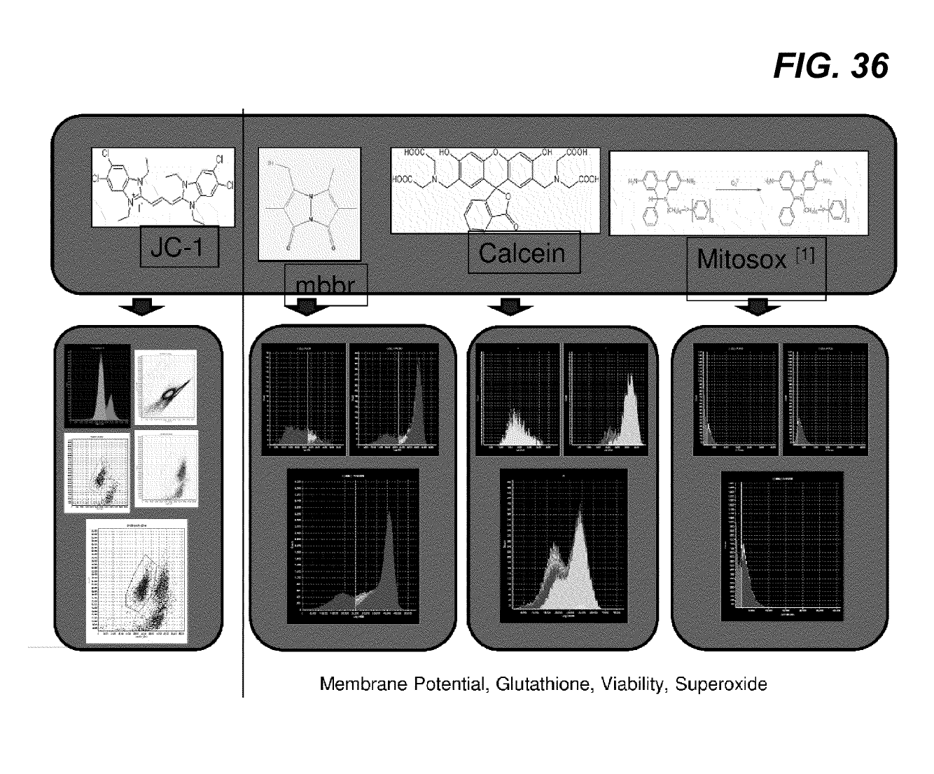

FIG. 36 shows chemical structures of example dyes (JC-1, mbbr, calcein, MitoSOX™) and data corresponding to those dyes;

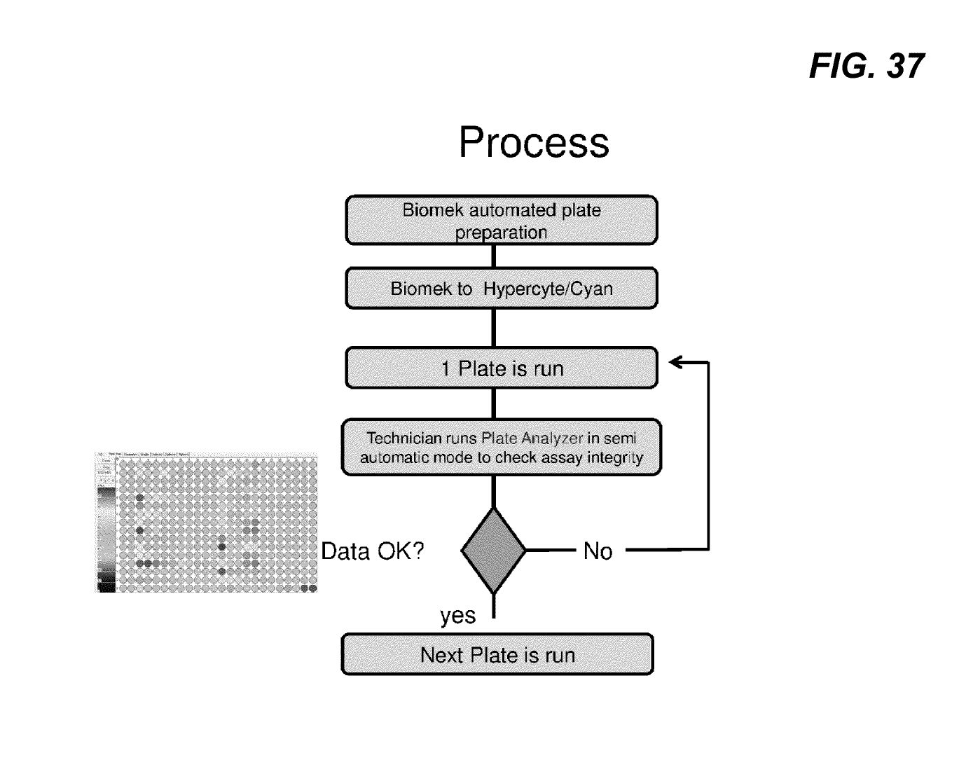

FIG. 37 shows a process of running a plate of samples;

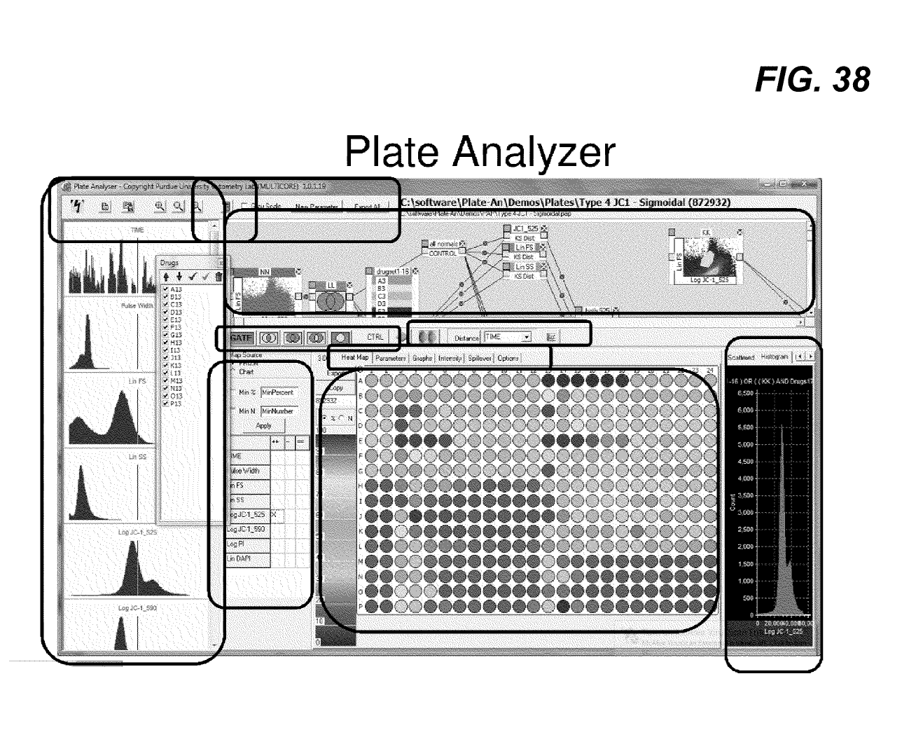

FIG. 38 shows a representative screen capture of a software program for flow-cytometric data analysis. This program is called “PlateAnalyzer.”

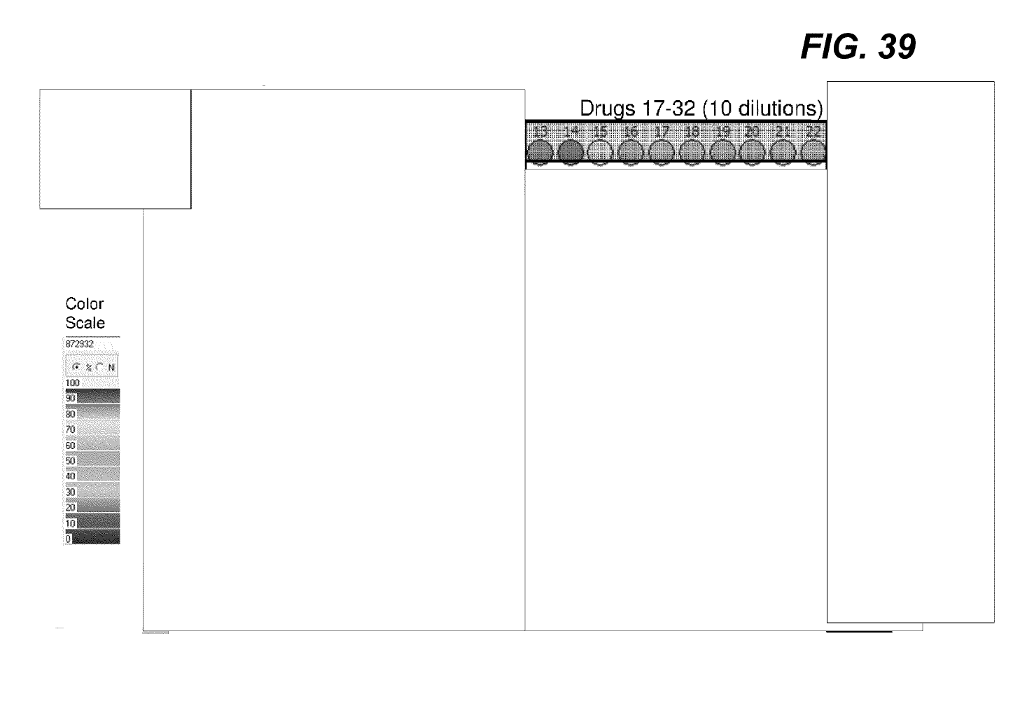

FIG. 39 shows a portion of a screen capture of PlateAnalyzer.

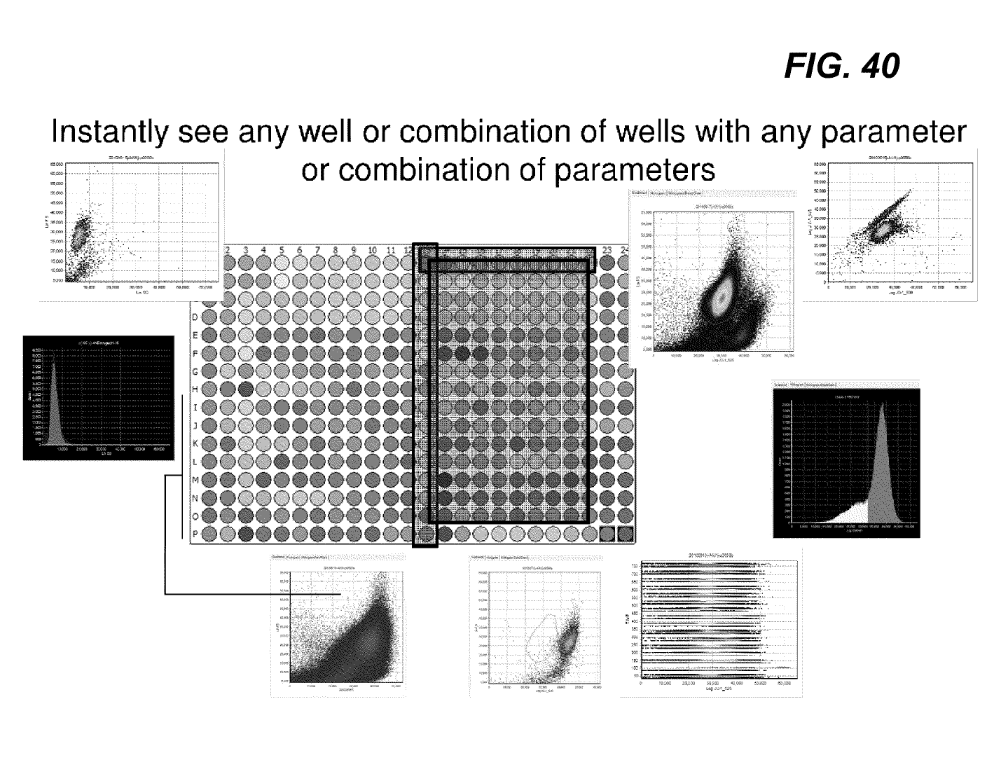

FIG. 40 shows exemplary representations of cytometric data.

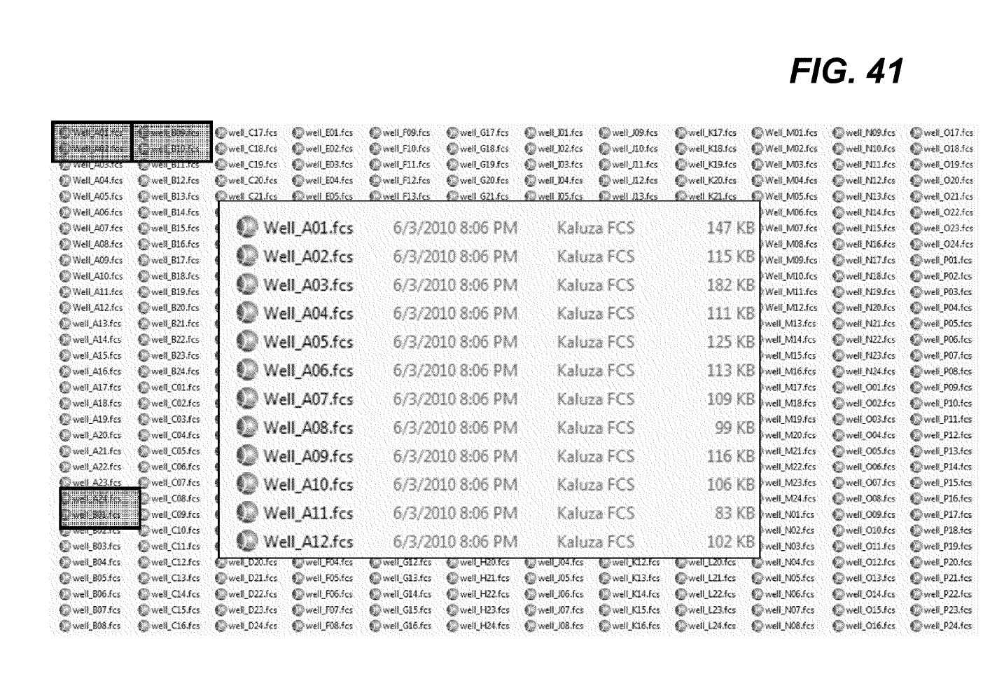

FIG. 41 shows a screen capture of a listing of FCS files, e.g., as described above with reference to FIG. 2.

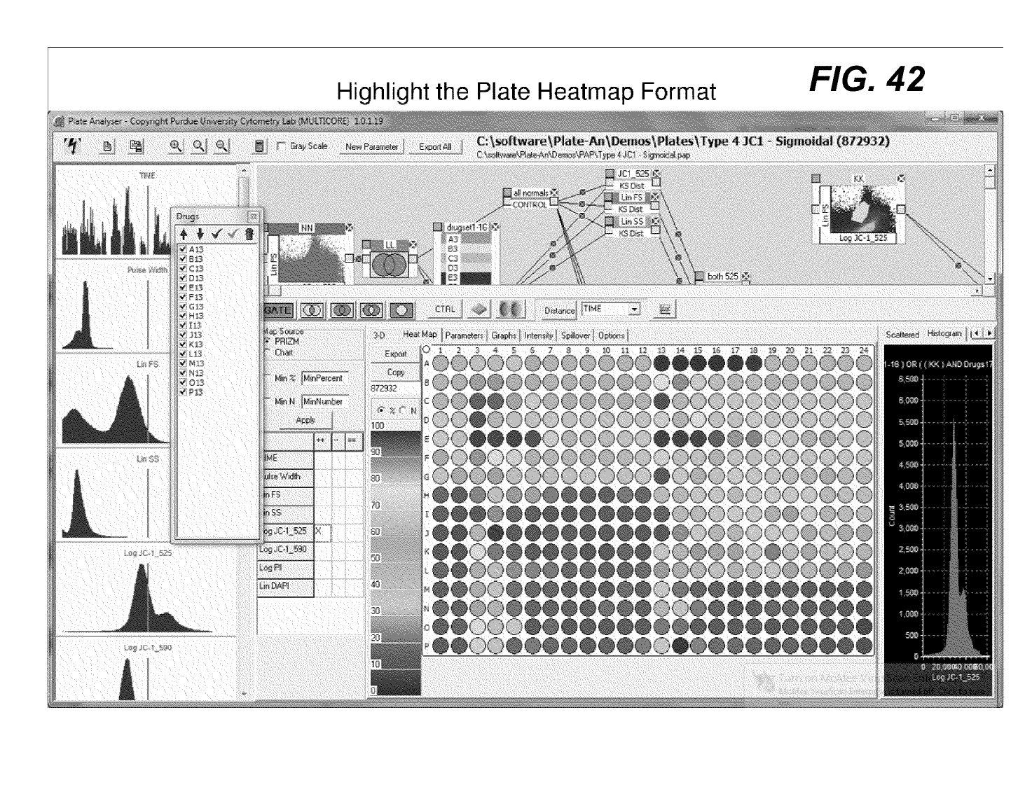

FIG. 42 shows a representative screen capture of PlateAnalyzer. “JC1_{—}525” is a “KS Dist” or KS distance box for performing gate-free analysis. “KK” is a scatterplot showing a gated region.

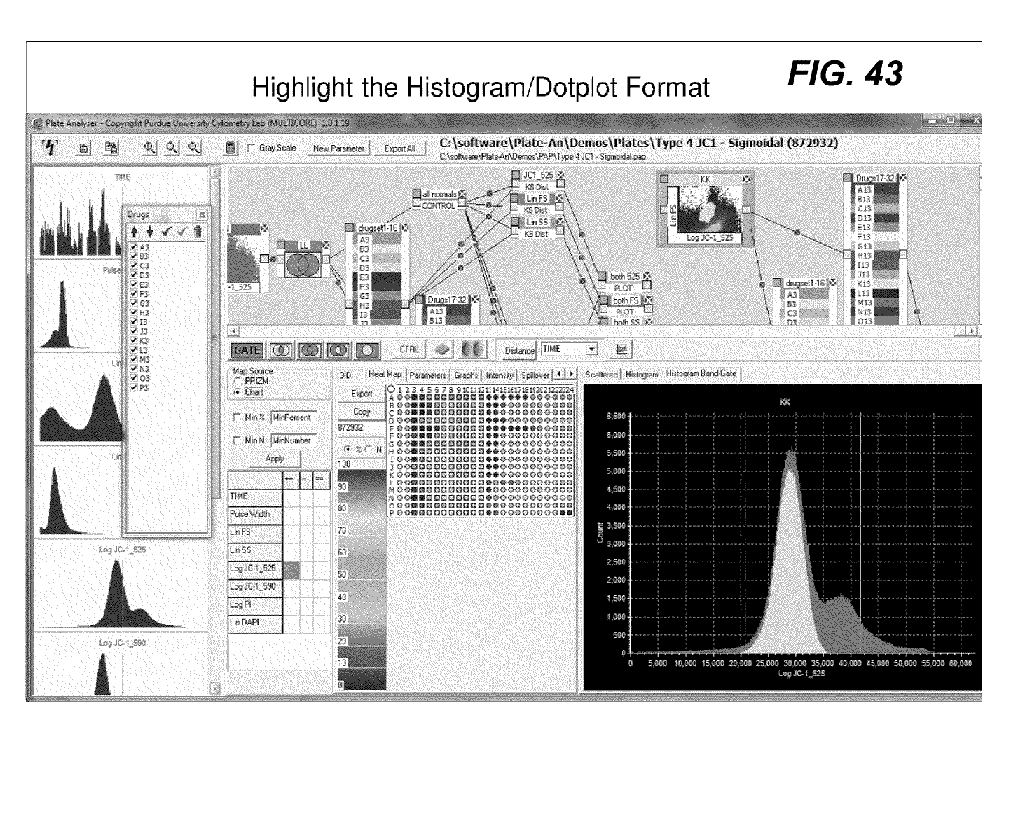

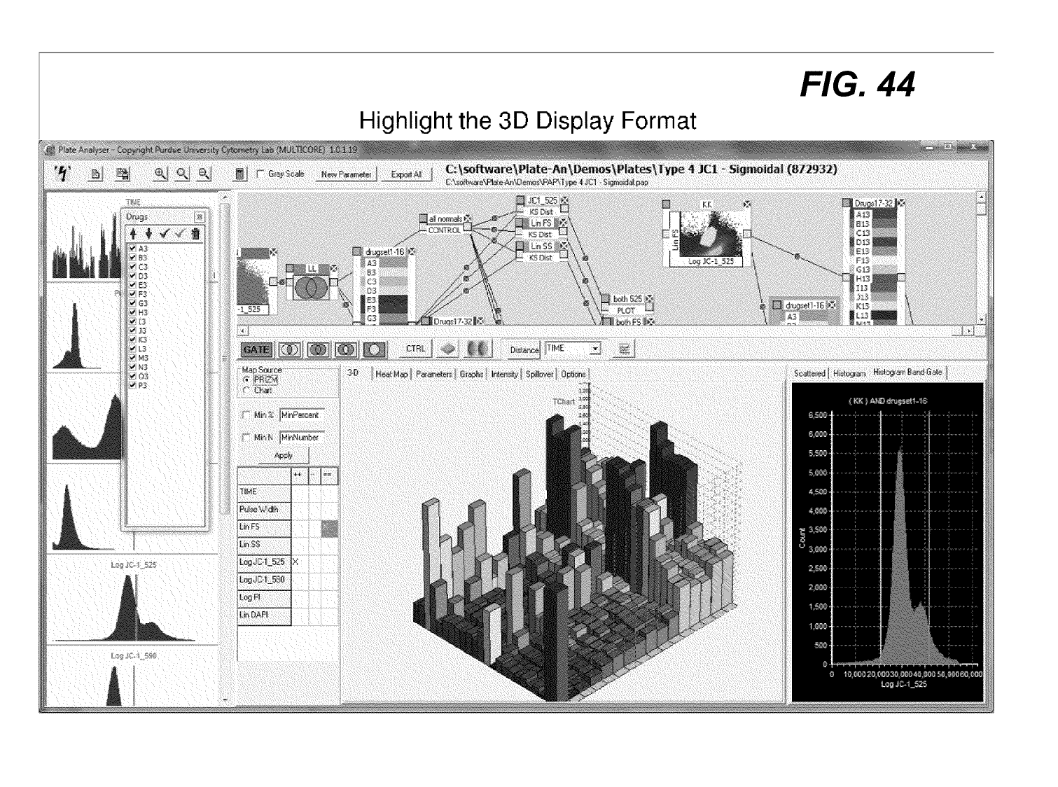

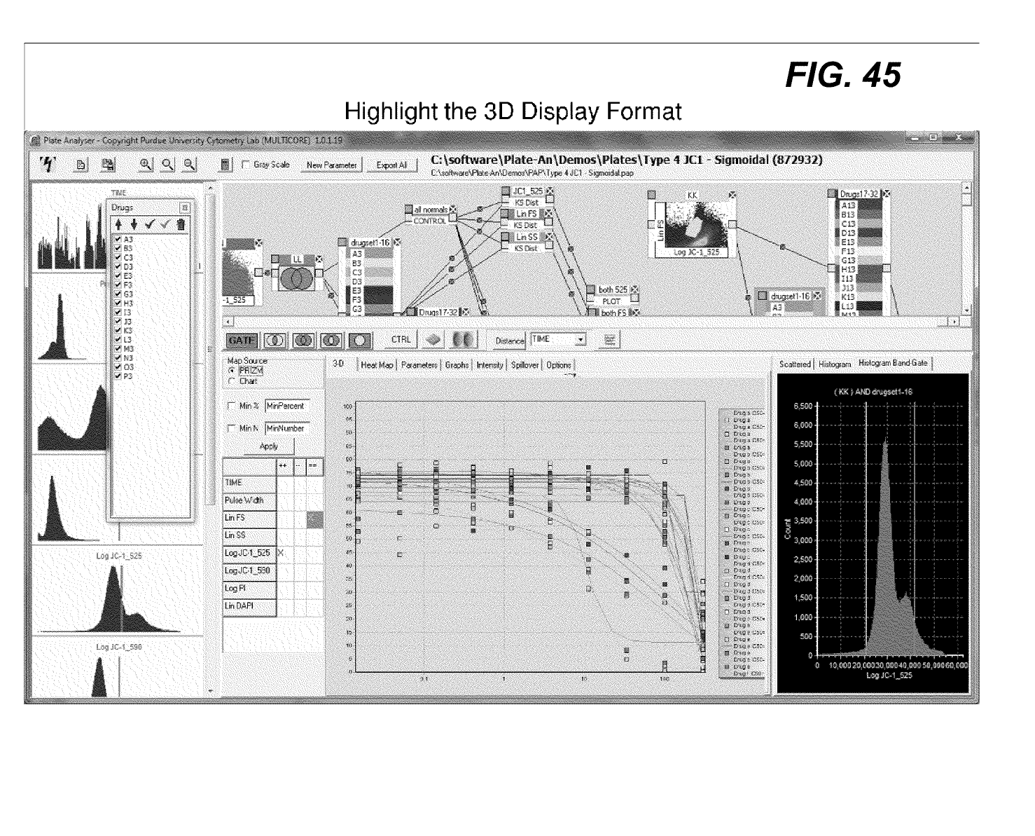

FIGS. 43-45 shows representative screen captures of PlateAnalyzer.

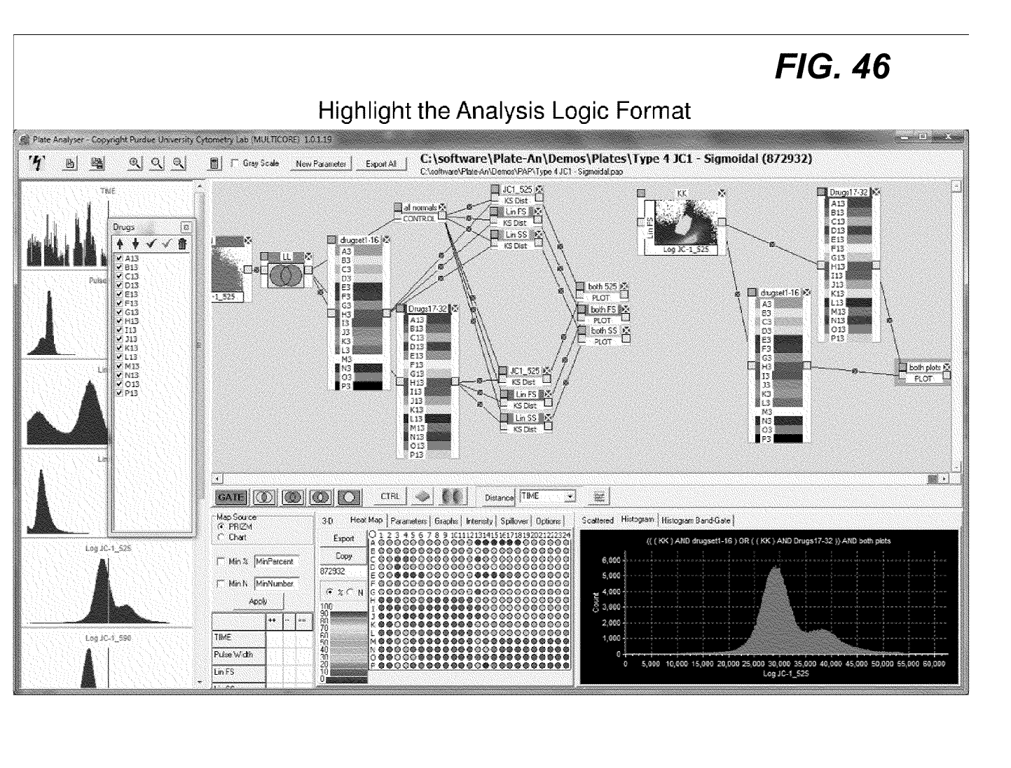

FIG. 46 shows a representative screen capture of PlateAnalyzer. In the upper-right portion, the dataflow leading to the “both 525 PLOT” boxes is a gate-free analysis, as evidenced by the lack of a gating region on the scatterplot, the presence of the “all normals CONTROL” box, and the “KS Dist” boxes. The dataflow leading to the “both plots PLOT” box is a gated analysis, as evidenced by the gating region in the “KK” scatterplot and the lack of “KS Dist” (or any other “dist”) boxes.

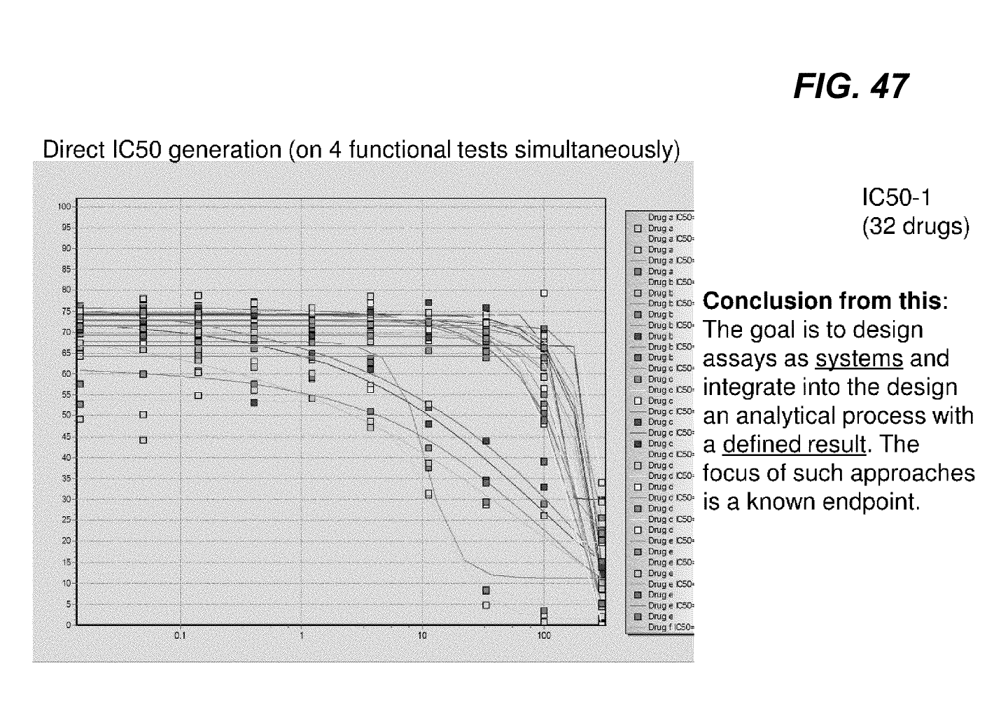

FIG. 47 shows a representative IC50 curve.

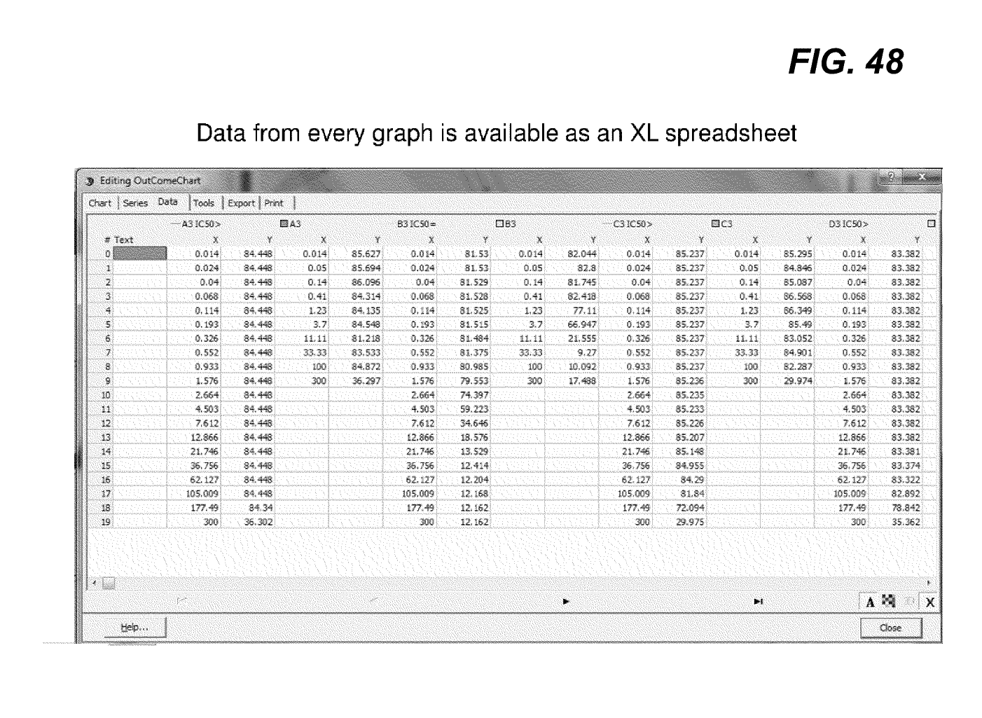

FIG. 48 shows a representative data table.

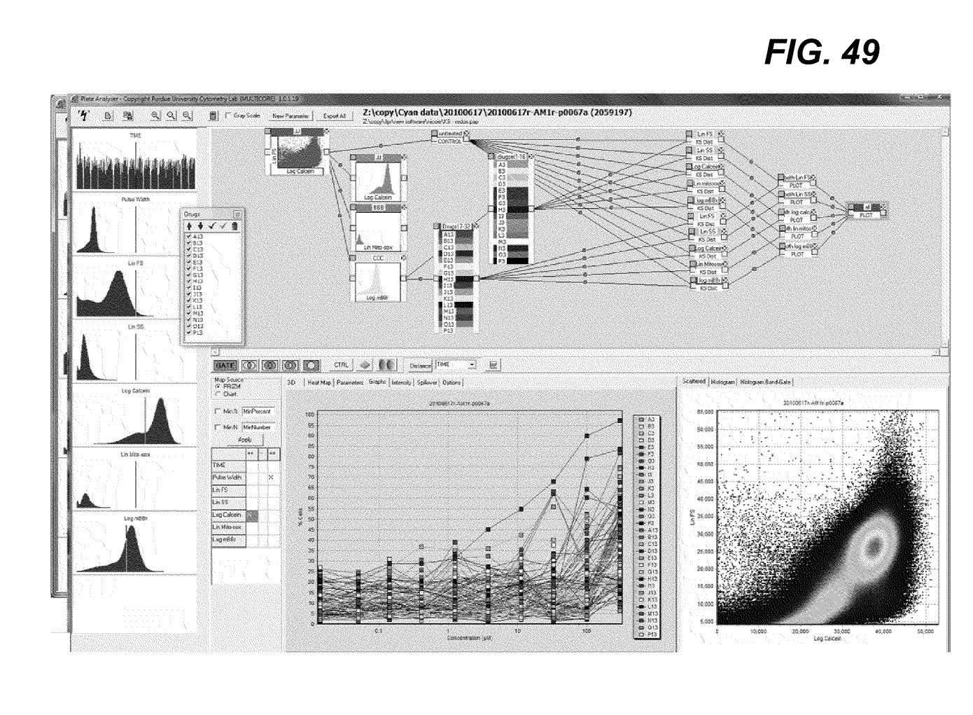

FIG. 49 shows a representative screen capture of PlateAnalyzer. The analysis (from “JJ” to “all PLOT”) is a gate-free analysis, as evidenced by the lack of gating in the JJ scatterplot or the histograms, the use of “untreated CONTROL”, and the “KS Dist” boxes.

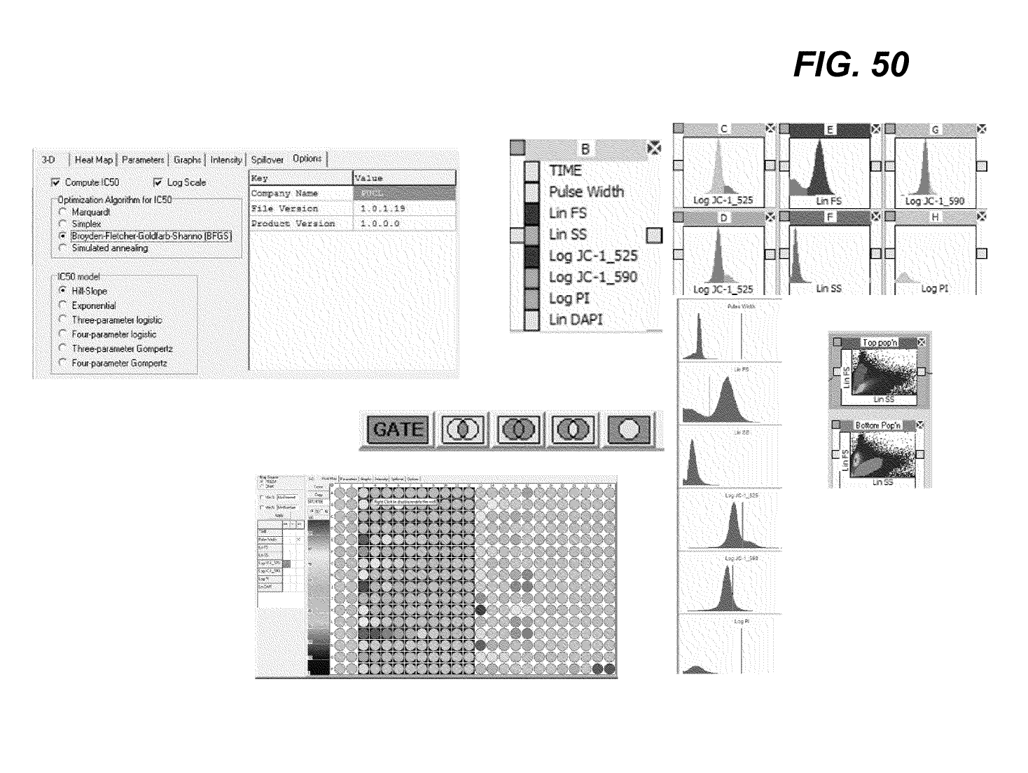

FIG. 50 shows a representative screen capture of PlateAnalyzer. “Top pop'n” and “Bottom Pop'n” show examples of scatterplots with gating regions.

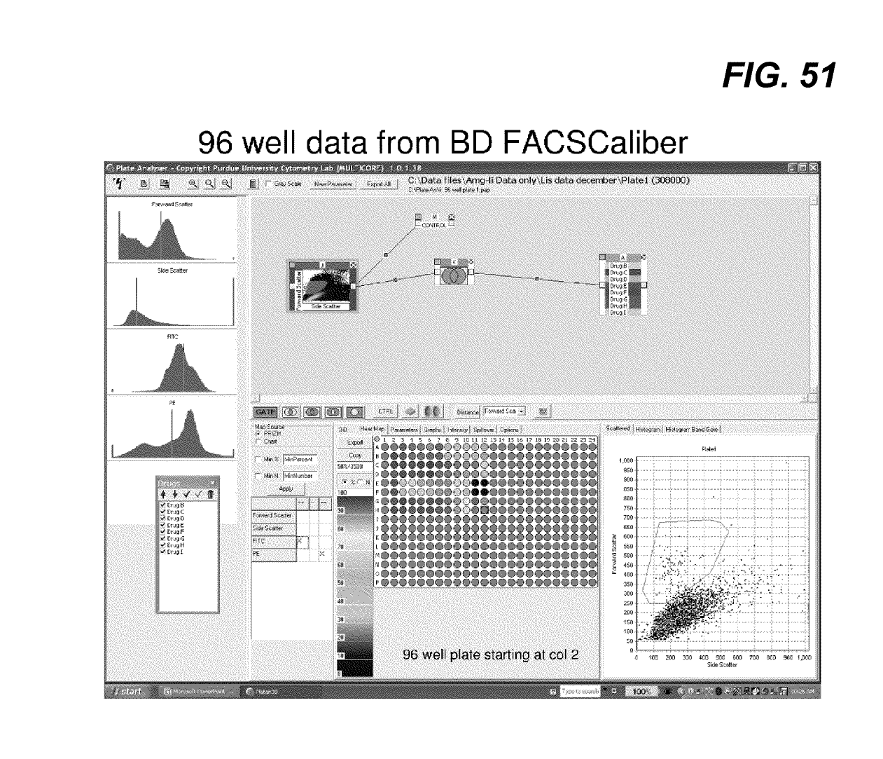

FIG. 51 shows a representative screen capture of PlateAnalyzer. The analysis is a gated analysis, per the region in “J”, the lack of “Dist” boxes, and the lack of connection of “M CONTROL” to a “Dist” box.

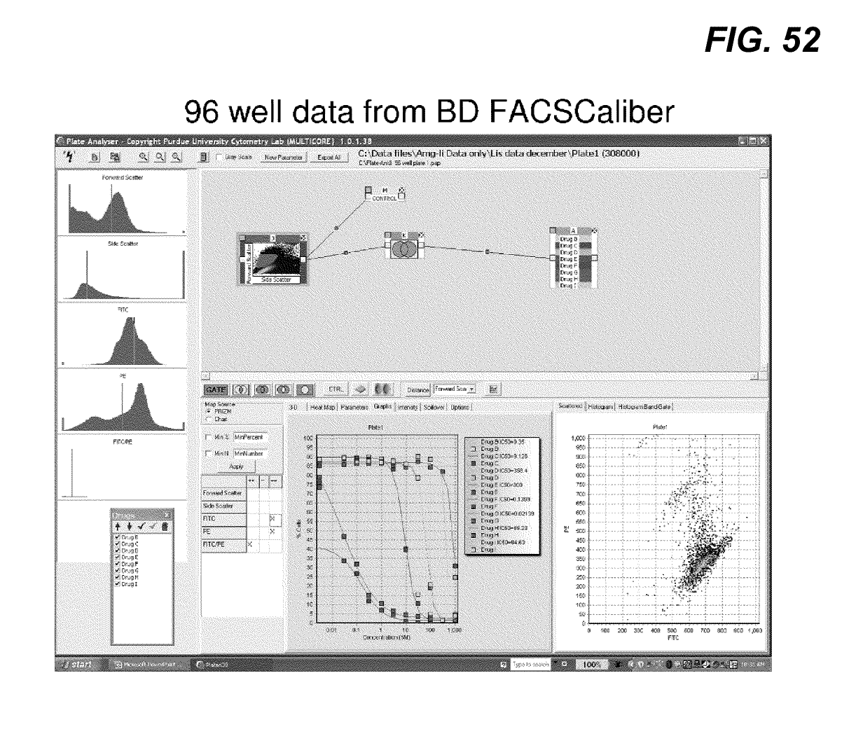

FIG. 52 shows a representative screen capture of PlateAnalyzer. A gated analysis is being performed.

Systems tested so far:
96 and 384 well plates from Beckman Coulter CyAn Cytometer (odd time parameter)
96 well plates from Becton Dickinson FACSCaliber (Integer)
96 well plates from Becton Dickinson LSRII Cytometer (Floating pt)
   It should be noted the data structure formats are very different on each of these systems despite all being “FCS” compliant.

It is no longer the case that “High throughput/high content screening is really an image based technology” or that “Flow cytometry is nice, but slow and cumbersome”

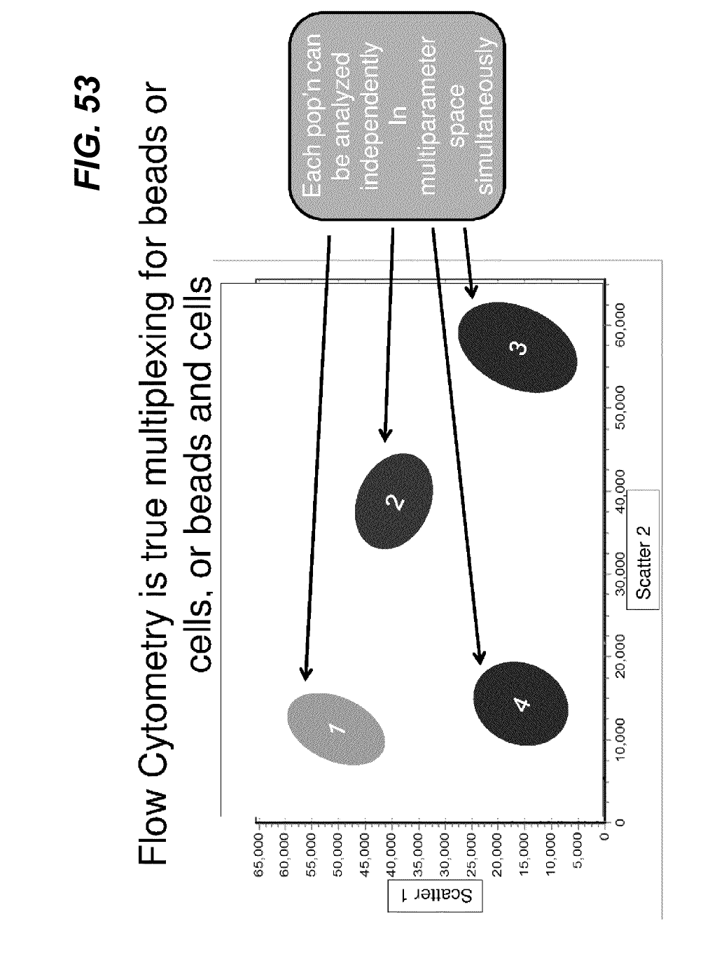

FIG. 53 shows an example of population areas in a scatterplot.

### Summary

Automation provides lower cost, better quality control and faster results
For HT flow cytometry the process blocking point is data analysis
A systems approach to analysis can now be followed in high parameter single cell with ease
Integration of advanced classification tools allows application to entire assay (plate) or multiple plates
Automated flow cytometry is here and is an effective technology for high throughput/content screening
Analysis can be at any time, on any computer, on most datasets
PlateAnalyzer could well be a breath of fresh air for flow cytometry

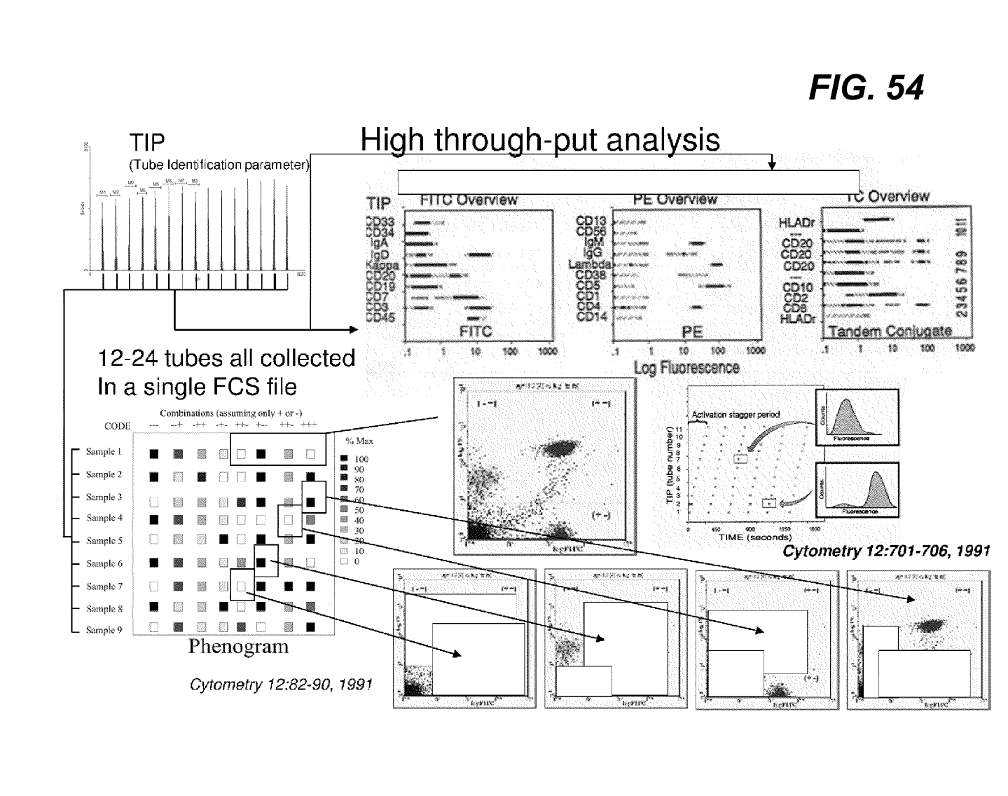

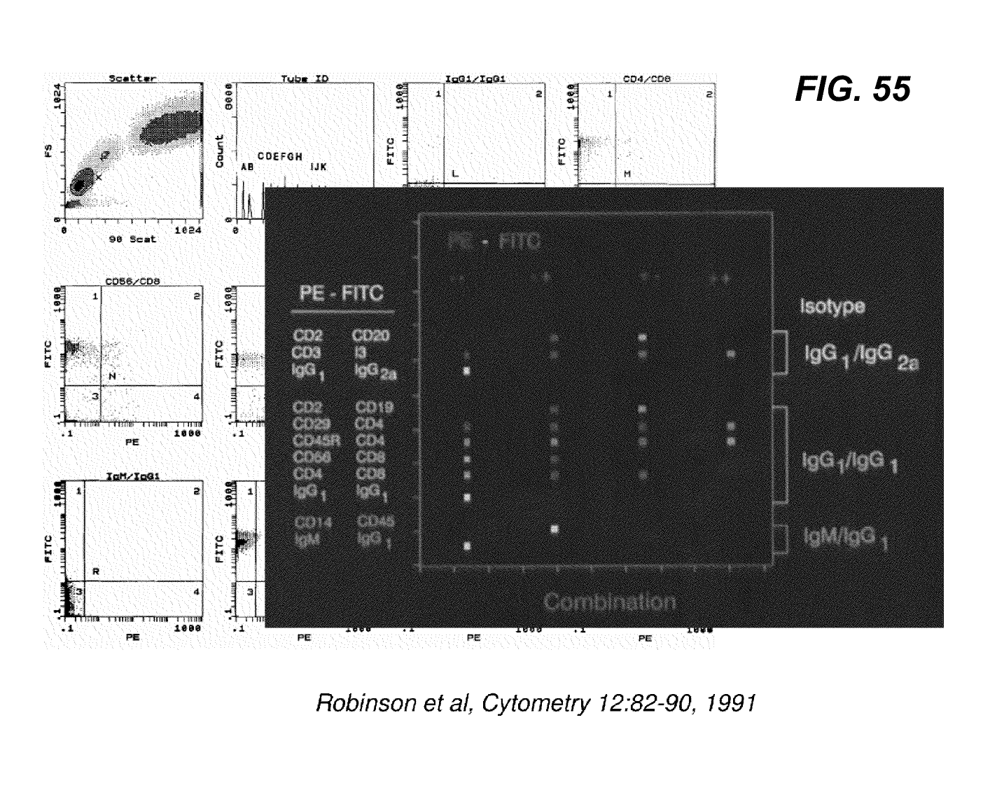

FIGS. 54 and 55 show examples of visualizations of flow-cytometry data.

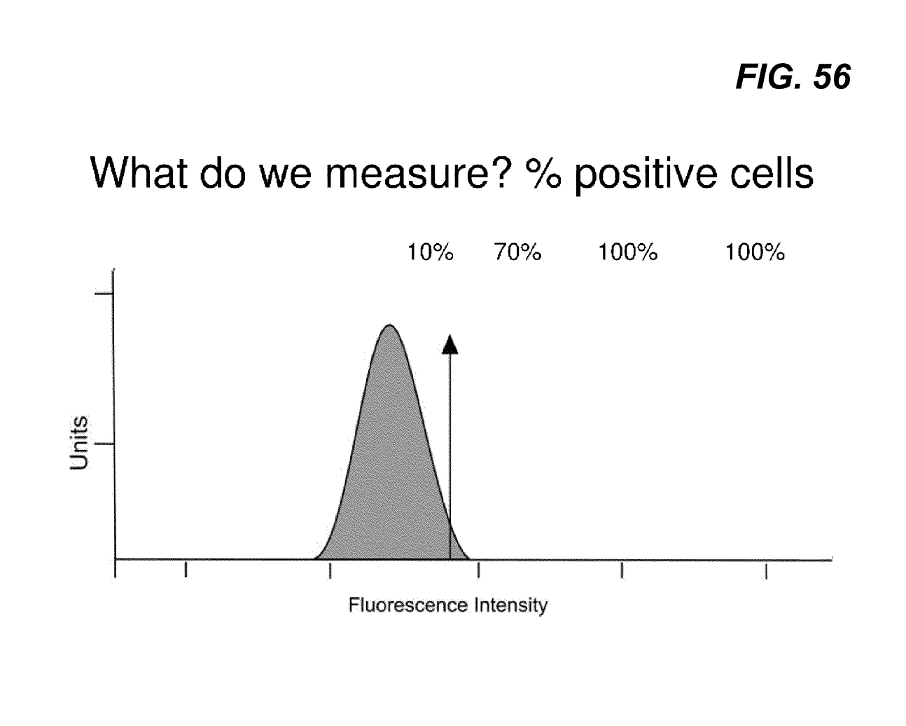

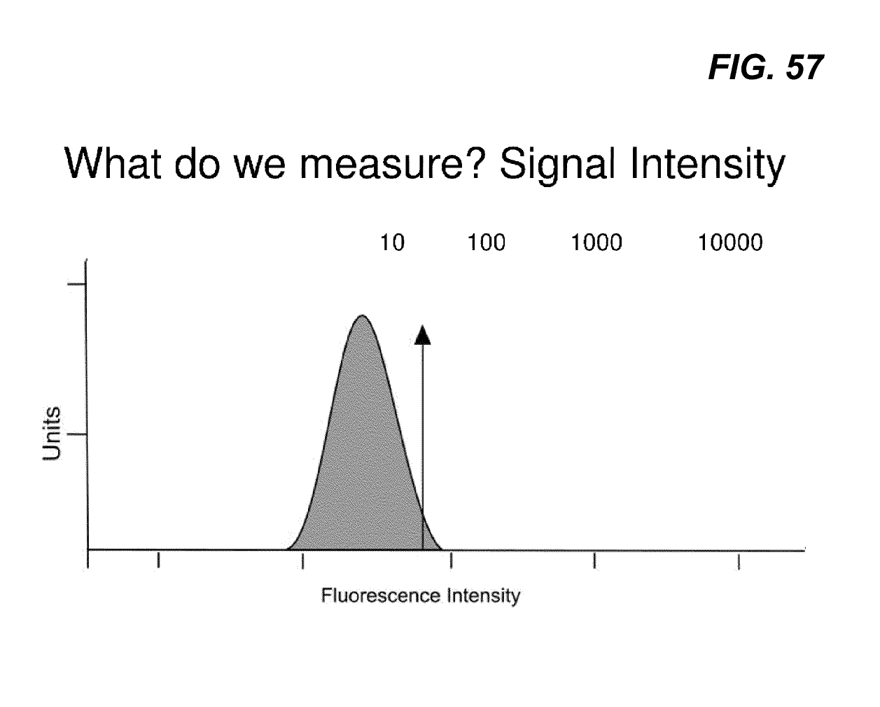

FIGS. 56-57 show examples of cytometry histograms.

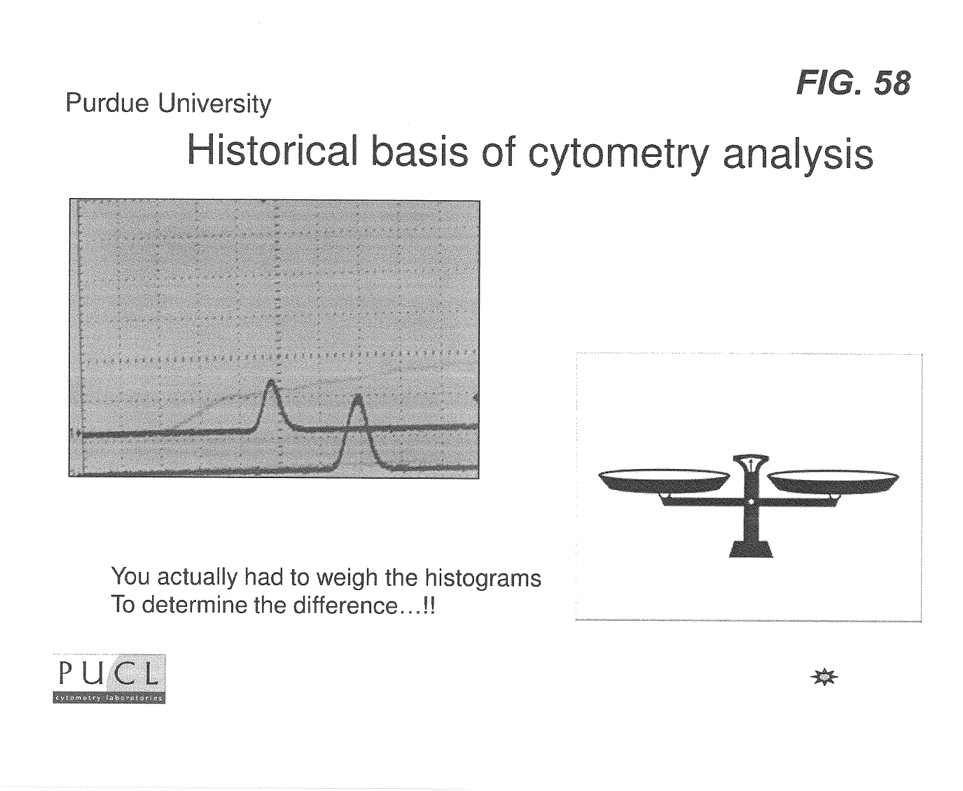

FIG. 58 shows a graphical representation of a historical basis of cytometry analysis.

Data can be collected, e.g., for the following:
1. FSC-A
2. SSC-A
3. FITC-A: Calcein (viability)
4. PE-A
5. PerCP-Cy5-5-A: MitoSOX™ (mitochondrial superoxide)
6. APC-A
7. Pacific Blue-A: mBBr (Cellular GSH)

The invention is inclusive of combinations of the aspects described herein. References to “a particular aspect” and the like refer to features that are present in at least one aspect of the invention. Separate references to “an aspect” or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A system for determining a parameter of a system under test from flow cytometry data, the parameter-determining system comprising:
a) a memory adapted to store a measured dataset of the flow cytometry data, wherein:
i) the measured dataset is organized according to at least a plurality of first factors and a plurality of second factors; and
ii) the measured dataset includes, for each of a plurality of combinations of one of the plurality of first factors with one of the plurality of second factors, measurement(s) of one or more variable(s); and
b) a processor communicatively connected with the memory and adapted to:
receive indication(s) of first-control data and second-control data in the measured dataset;
retrieve the first-control data and the second-control data from the stored measured dataset in the memory;
automatically establish a distance function using the first-control data and the second-control data;
receive indication(s) of reference data and test data in the measured dataset, wherein test data includes data from at least two different ones of the second factors;
retrieve the reference data and the test data from the stored measured dataset in the memory;
using the determined distance function, compute a respective distance between the reference data and the test data for each of the ones of the second factors in the test data;
fit a curve to the computed respective distances with reference to the ones of the second factors in the test data; and
perform a step of analyzing the fitted curve to determine the parameter.

2. The system according to claim 1, wherein the first-control data and the second-control data have respective disjoint ranges of values for the corresponding measurement(s) of a selected one of the variable(s), and the reference data or the test data includes values greater than a selected threshold and values less than the selected threshold, wherein the selected threshold is between the respective disjoint ranges of values.

3. The system according to claim 1, wherein each of the first-control data and the second-control data have a respective mode for the corresponding measurement(s) of a selected one of the variable(s), and the reference data or the test data includes values greater than a selected threshold and values less than the selected threshold, wherein the selected threshold is between the respective modes.

4. The system according to claim 1, wherein the parameter is IC50.

5. The system according to claim 1, further including a flow-cytometry subsystem adapted to produce the measured data set and provide it to the memory to be stored.

6. The system according to claim 1, wherein the processor is further adapted to:
receive a target range; and
automatically produce an indication of each first factor for which the computed parameter is within the target range.

7. A method of determining a parameter of a system under test from flow cytometry data, comprising;
receiving a measured dataset of the flow cytometry data, the measured dataset containing measurements of a variable, each measurement corresponding to one of a plurality of modifying factors and to one of a plurality of series factors, wherein the measurements include first-control measurements, second-control measurements, reference measurements, and test measurements;
using a controller, automatically establishing a distance function using the first-control measurements and the second-control measurements;
receiving a first modifying-factor selection of one of the plurality of modifying factors;
using the controller, automatically computing respective distances, using the established distance function, between respective sets of the test measurements and at least some of the reference measurements, wherein:
the measurements in each set of the test measurements correspond to the first modifying-factor selection;
each set of the test measurements corresponds to a respective, different one of the series factors; and
the measurements in each set of the test measurements correspond to the series factor of that set;
using the controller, automatically fitting a curve to the computed respective distances as a function of the respective ones of the series factors; and
using the controller, automatically determining the parameter from the fitted curve.

8. The method according to claim 7, wherein the curve-fitting step fits a sigmoid curve and the determining-the-parameter step includes automatically locating the series factor corresponding to the inflection point of the fitted curve and selecting that series factor as the parameter.

9. The method according to claim 7, wherein the distance function is a quadratic form (QF) distance and the computing-distances step includes computing QF distances between the respective sets of the test measurements and the at least some of the reference measurements.

10. The method according to claim 9, wherein the establishing step includes using metric learning to determine parameters of the QF distance function so that the distance according to the distance function between any two of the first-control measurements or between any two of the second-control measurements is less than the distance between any one of the first-control measurements and any one of the second-control measurements.

11. The method according to claim 7, wherein the computing-distances step includes automatically determining a first density map of the measurements in at least one of the sets of test measurements, automatically determining a second density map of the at least some of the reference measurements, and automatically computing a distance between the first density map and the second density map using the established distance function.

12. The method according to claim 7, wherein the first-control measurements of a selected one of the variable(s) and the second-control measurements of the selected one of the variable(s) include respective disjoint ranges of values, and the reference data or the test data includes values of the selected one of the variable(s) greater than a selected threshold and values less than the selected threshold, wherein the selected threshold is between the respective disjoint ranges of values.

13. The method according to claim 7, wherein each of the first-control measurements of a selected one of the variable(s) and the second-control measurements of the selected one of the variable(s) includes a respective mode, and the reference data or the test data includes values of the selected one of the variable(s) greater than a selected threshold and values less than the selected threshold, wherein the selected threshold is between the respective disjoint modes.

14. The method according to claim 7, wherein the parameter is IC50.

15. The method according to claim 7, wherein the determining-parameter step includes either:
automatically locating an inflection point of the fitted curve and selecting the parameter as the abscissa value of the located inflection point; or
automatically determining two horizontal asymptotes of the fitted curve and selecting the parameter as the abscissa value at which the fitted curve has an ordinate value substantially halfway between the ordinate values of the determined horizontal asymptotes.

16. The method according to claim 7, further including:
receiving a target range; and
using the controller, automatically producing an indication of each first factor for which the computed parameter is within the target range.

17. A non-transitory tangible computer-readable medium having instructions stored thereon for processing a dataset, the dataset including measurements of a variable, each measurement corresponding to one of a plurality of modifying factors and to one of a plurality of series factors, wherein the measurements include first-control measurements, second-control measurements, reference measurements, and test measurements, the instructions comprising:
a) instructions to automatically establish a distance function using the first-control measurements and the second-control measurements;
b) instructions to await receipt of a first modifying-factor selection of one of the plurality of modifying factors;
c) instructions to select a plurality of sets of the test measurements so that the measurements in each set correspond to the first modifying-factor selection and to a respective, different one of the series factors
d) instructions to compute respective distances, using the established distance function, between the respective sets of the test measurements and at least some of the reference measurements;
e) instructions to fit a curve to the computed respective distances as a function of the respective ones of the series factors; and
f) instructions to determine the parameter from the fitted curve.

18. A method of determining differences in one or more biological response(s) by cell(s) to factor(s), the method comprising:
receiving a measured dataset, wherein the measured dataset includes measurement(s) of one or more of the biological response(s) to one or more substance(s), each measurement corresponding to one of a plurality of values of a first one of the factor(s) and to one of a plurality of values of a second one of the factor(s), each substance corresponding to the respective first-factor value and the respective second-factor value;
receiving a selection of one or more of the measured biological response(s);
receiving an indication that one or more of the measurement(s) in the measured dataset are reference measurement(s), and one or more of the measurement(s) in the measured dataset that are not reference measurement(s) are test measurement(s);
receiving an indication of a grouping to compare;
using a controller, automatically assembling a reference matrix by selecting from the reference measurement(s) according to the received grouping indication and automatically assembling a test matrix by selecting from the test measurement(s) according to the received grouping indication; and
using the controller, automatically computing a difference score between the control matrix and the test matrix

19. The method according to claim 18, wherein the reference matrix and the test matrix are three-dimensional matrices.

20. The method according to claim 18, further including comparing the computed difference score to a selected threshold and reporting if the difference score exceeds the threshold.
